(19) United States
(12) Patent Application Publication
(10) Pub. No.: US 2025/0366483 A1
(43) Pub. Date: Dec. 4, 2025

(54) Satiety Promoting Compositions, Foodstuffs and Methods of Production Thereof

(71) Applicants: Quadram Institute Bioscience, Norwich Norfolk (GB); King's College London, London (GB)

(72) Inventors: Cathrina Edwards, Norwich (GB); Peter Ellis, London (GB); Balazs Bajka, London (GB)

(21) Appl. No.: 18/870,028

(22) PCT Filed: May 26, 2023
(86) PCT No.: PCT/GB2023/051406

§ 371 Date: Nov. 27, 2024

(30) Foreign Application Priority Data
May 30, 2022 (GB) 2208002.2
Nov. 2, 2022 (GB) 2216254.9

(51) Int. Cl. A21D 2/36; A23L 33/00; A23L 33/22

(52) U.S. Cl. CPC A21D 2/362; A23L 33/22; A23L 33/30

(57) ABSTRACT

Satiety promoting composition and methods of producing the same wherein the fibre structure of the composition influences enteroendoctrine-mediated appetite regulation. The composition includes intact cells from at least one legume.

The global pandemic of obesity and cardiometabolic disease is partially fueled by the increased intake of processed foods made from highly refined ingredients (Swinburn et al., 2011) (Mozaffarian et al., 2011; Reynolds et al., 2019). This can be attributed to disruption of intrinsic food microstructure, resulting in significant changes in digestion kinetics and nutrient bioavailability. For example, it is increasingly recognised that the processing of whole grains into physically disrupted and more refined ingredients results in food structures that are rapidly digested, and consequently high glycaemic and less satiating than minimally-processed whole-foods (Aygul Dagbasi et al., 2020; Fardet, 2016). By designing new food ingredients that preserve the intrinsic structure of dietary fibre in the form of intact plant cell walls, it is possible to regulate macronutrient digestion for improved postprandial glycaemia, satiety and cardiometabolic health.

Indeed, there is evidence that the slowing down in digestion and absorption kinetics can benefit the enteroendocrine response, glucose homeostasis and satiety. Glucagon-like peptide 1 (GLP-1) and peptide-YY (PYY) are two important anorexigenic gut hormones which have a major role in regulation of glucose homeostasis and food intake (Pais et al., 2016; Reimann & Gribble, 2016). These hormones have attracted considerable interest as pharmacological targets and are successfully used in obesity management (Knudsen & Lau, 2019), consequently, their satiety-promoting effects are well documented (Flint et al., 1998; Steinert et al., 2017). These hormones can be produced after meal ingestion (‘postprandially’) when bioaccessible macronutrient digestion products (e.g., peptides, saccharides, fatty acids from digestion of protein, starch and lipids, respectively) bind nutrient-sensing receptors of specialised enteroendocrine cells within the intestinal epithelium [cite]. However, the density of enteroendocrine cells varies throughout the intestine, with the number of GLP-1 and PYY—secreting cells increasing distally. It has therefore been suggested that foods that are rapidly digested and readily absorbed (including refined carbohydrate sources) have limited capacity to stimulate satiety via the distal gut (A. Dagbasi et al., 2020). Development of slowly-digested foods with distal nutrient delivery is needed to stimulate gut-mediated production of satiety-promoting hormones (A. Dagbasi et al., 2020).

Cotyledon cells from legumes (including chickpeas and other pulses) are increasingly attracting interest for their natural bioencapsulation properties, which provides a potential route to deliver nutrients to the distal gut (Pallares Pallares et al., 2021; Verkempinck et al., 2020; Xiong et al.). Owing to their primary plant cell wall (dietary fibre) structure and properties, cotyledon tissues of cooked pulses have a tendency to separate into intact cells (Edwards et al., 2021; Jarvis et al., 2003), such that macronutrients (intracellular starch, proteins and lipids) remain encapsulated by the primary cell walls (Edwards et al., 2021; M. M.-L. Grundy et al., 2016; Holland et al., 2020; Jarvis et al., 2003). Evidence from laboratory (Bhattarai et al., 2017; Dhital et al., 2016; Edwards et al., 2021; Pallares Pallares et al., 2018; Rovalino-Córdova et al., 2019) and human studies (Noah et al., 1998; Petropoulou et al., 2020) shows that cotyledon cells from cooked pulses can resist digestive conditions of the stomach and small intestine, and give rise to a low glycaemic response. The slow release of encapsulated nutrients from intact legume cells have already been shown to underpin their low glycaemic properties of pulses (Bajka et al., 2021; Golay et al., 1986; Tovar et al., 1992), and may also be critical to their beneficial effects on obesity and cardiometabolic disease risk, which have been widely demonstrated (Kim et al., 2016; Papanikolaou & Fulgoni, 2008; Ramdath et al., 2016; Sievenpiper et al., 2009; Viguiliouk et al., 2019).

We have recently shown that this natural bioencapsulation property of pulses can be exploited to obtain a novel cellular flour with high levels of encapsulated starch (‘type 1 resistant starch’) (Bajka et al., 2021; Butterworth et al., 2021; Delamare et al., 2020; Edwards, Ryden, Pinto, van der Schoot, Stocchi, Perez-Moral, Butterworth, Bajka, Berry, Hill, et al., 2020) and demonstrated its use to lower the starch digestibility and glycaemic potency of starch-rich foods (Bajka et al., 2021; Delamare et al., 2020). Recently, we reported that inclusion of intact chickpea cell flours within a standard white bread formulation reduced the postprandial glucose concentrations without significant effects on product palatability (Bajka et al., 2021). Laboratory studies by our group (Edwards, 2014; Edwards et al., 2018; Edwards et al., 2021; Edwards, Ryden, Pinto, van der Schoot, Stocchi, Perez-Moral, Butterworth, Bajka, Berry, Hill, et al., 2020) and others (Dhital et al., 2016; Melito & Tovar, 1995; Pallares Pallares et al., 2018; Rovalino-Córdova et al., 2018, 2019; Würsch et al., 1986) indicate that intact legume cell walls slow the release of encapsulated starch during simulated digestion.

In a first aspect of the invention there is provided a dietary composition wherein the fibre structure of said composition influences enteroendocrine-mediated appetite regulation, characterised in that said composition includes intact cells from at least one legume.

In a second aspect of the invention there is provided a method of influencing appetite regulation by inclusion of intact legume cells in a dietary composition, foodstuffs and/or foodstuff precursors.

Typically the appetite regulation is enteroendocrine-mediated.

Typically the dietary composition is supplemented with intact legume cells. Further typically the legume cells are provided as a powder.

Typically the composition includes at least 10% by weight cellular legume powder. Further typically the powder includes and/or substantially comprises intact plant cells.

Preferably the legume is from the Fabaceae family. Further preferably the cellular powder is cellular chickpea powder (CCP).

In one embodiment the cellular powder is included as an ingredient in a foodstuff and/or foodstuff formulation or precursor. Typically the cellular powder is included as an ingredient in dough or a bread precursor composition.

In a preferred embodiment of the invention the intact plant cells replace refined flours in foodstuffs and/or processed foods.

Typically the modified flours or composition stimulate an anorexigenic response when consumed. Further typically the anorexigenic response has benefits on body-weight management and/or cardiometabolic risk.

In one embodiment the flour is wheat flour. Typically at least part of the wheat flour is replaced with legume cell flour or powder.

Further typically the use of the cellular flour or powder results in significantly elevated and/or sustained release of gut hormones. In one embodiment the use of the cellular flour and/or powder results in increased satiety and/or attenuated postprandial glycaemia.

Typically the composition includes up to substantially 60% wt cellular powder. Further typically the composition includes substantially 30-60% wt cellular powder.

In a second aspect of the invention there is provided a method of influencing enteroendocrine-mediated appetite regulation by inclusion of intact legume cells in foodstuffs and/or foodstuff precursors.

Typically the intact cells influence any one or any combination of gastric inhibitory polypeptide (GIP), glucagon-like peptide 1 (GLP-1) and peptide-YY (PYY).

In a third aspect of the invention there is provided a flour composition, said composition including a portion of intact legume cells.

Typically the cells are included in, and/or replace a portion of bread flour. Further typically the bread flour includes wheat flour.

In one embodiment the cells are legume cells. Typically the legumes are peas or chickpeas. Further typically the legume cells are provided in powder or flour.

In a further aspect of the invention there is provided a method of modifying foodstuffs to provide controlled release of free amino acids, by including substantially intact cells from at least one legume.

In a yet further aspect of the invention there is provided a method of improving the bioaccessibility of amino acids in a foodstuff by including cellular legume powder.

Typically the amino acids are essential amino acids.

In one embodiment the foodstuff is flour. Typically the foodstuff is bread flour or bread.

In one embodiment up to 60% of the wheat flour is replaced by cellular legume powder. Typically the legume powder is chickpea powder.

Typically said amino acids are from protein digestion and compared with unmodified foodstuffs.

In a yet further aspect of the invention there is provided a method to improve the amount and/or diversity of bioavailable essential amino acids in bread products by replacement of at least a portion of the bread flour with cellular chickpea powder.

Typically the bread flour is wheat flour.

In a further aspect of the invention there is provided a method of liberating bio-accessible and/or bioavailable essential amino acids by the digestion of encapsulated legume protein.

Typically the enrichment of white wheat bread with cellular legume powder improves is digested into bioaccessible small peptides and free amino acids.

Preferably the legume is chickpea.

In a further aspect of the invention there is provided a dietary composition or foodstuff wherein the fibre structure of said composition influences enteroendocrine-mediated appetite regulation, characterised in that said composition includes intact cells from at least one legume.

Typically the dietary composition is supplemented with intact legume cells.

In one embodiment the legume cells are provided as a powder.

Typically the composition includes at least 10% by weight cellular legume powder.

Preferably the legume is from the Fabaceae family. Further preferably the cellular powder is cellular chickpea powder (CCP).

In an embodiment of the invention the cellular powder is included as an ingredient in a foodstuff and/or foodstuff formulation or precursor.

Typically the cellular powder is included as an ingredient in dough or a bread precursor composition.

In one embodiment the use of the cellular flour and/or powder results in increased satiety and/or attenuated postprandial glycaemia.

Typically the composition includes up to substantially 60% wt cellular powder. Further typically the composition includes substantially 30-60% wt cellular powder.

In a further aspect of the invention there is provided a method of influencing enteroendocrine-mediated appetite regulation by inclusion of intact legume cells in foodstuffs and/or foodstuff precursors.

In a further aspect of the invention there is provided a method of modifying foodstuffs to provide a higher amount of bioavailable total free amino acids, by including substantially intact cells from at least one legume.

Typically the amino acids are from protein digestion and compared with unmodified foodstuffs.

Specific embodiments of the invention are now described with reference to the following figures, wherein:

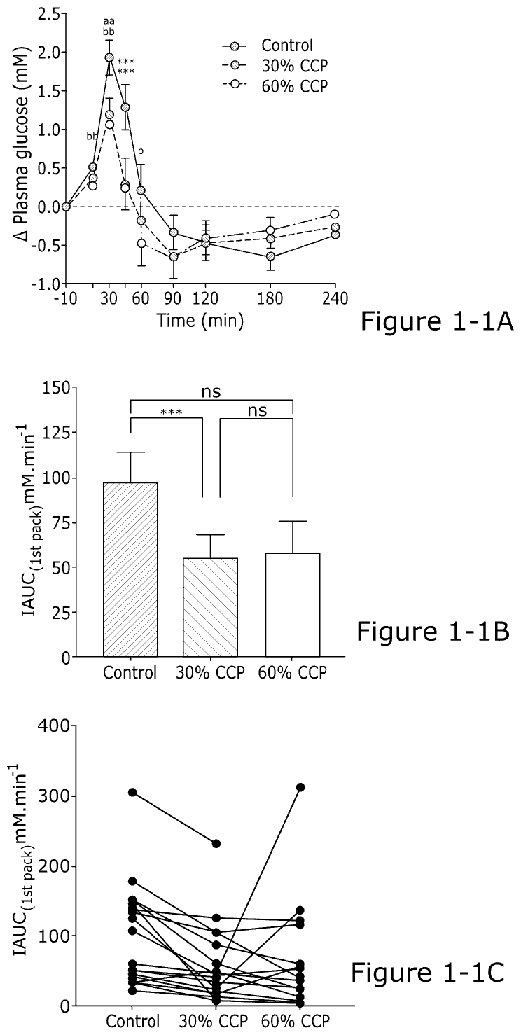

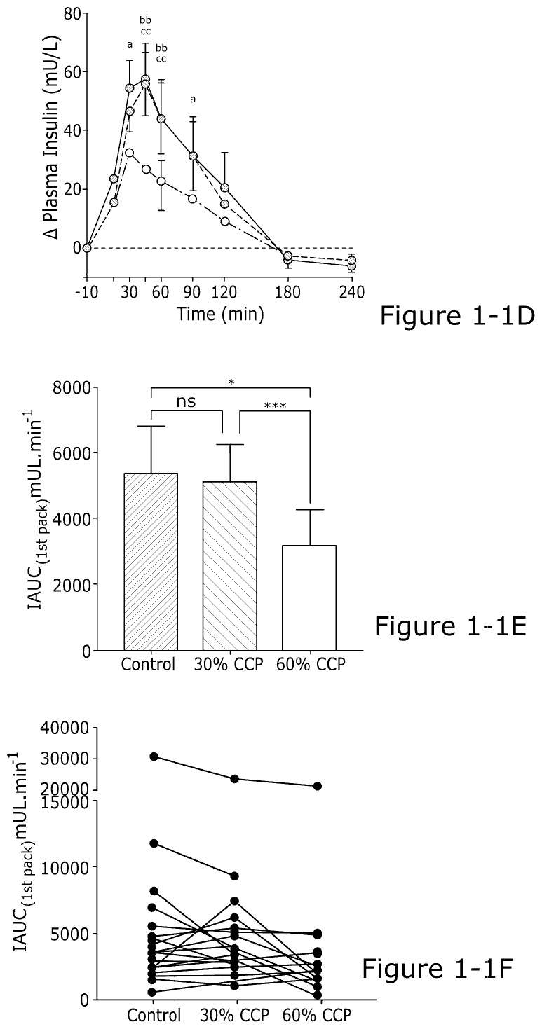

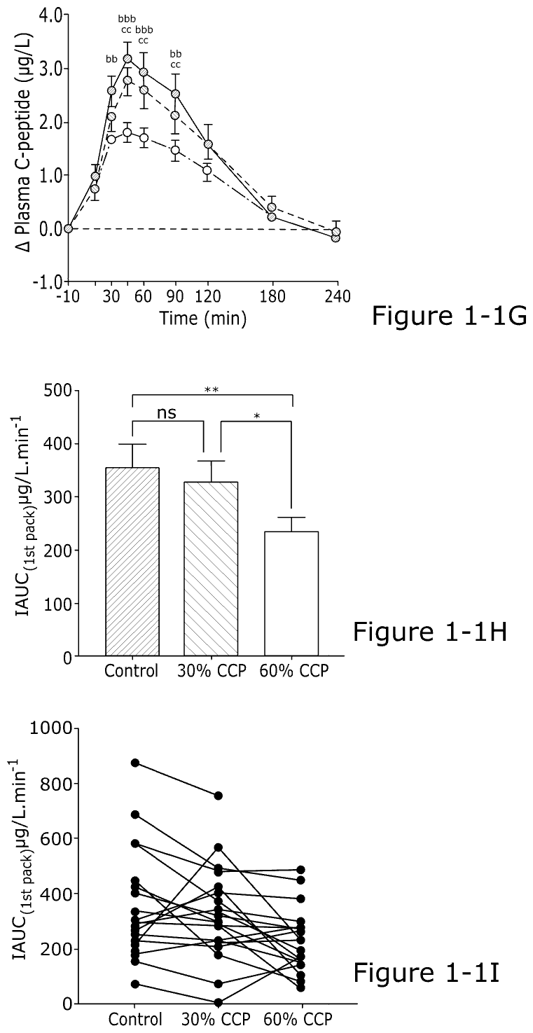

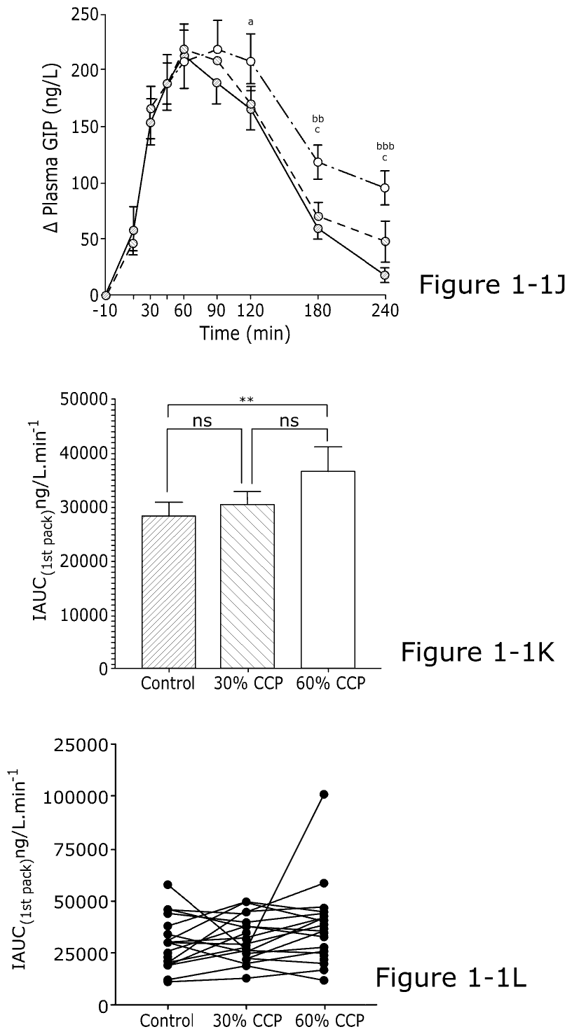

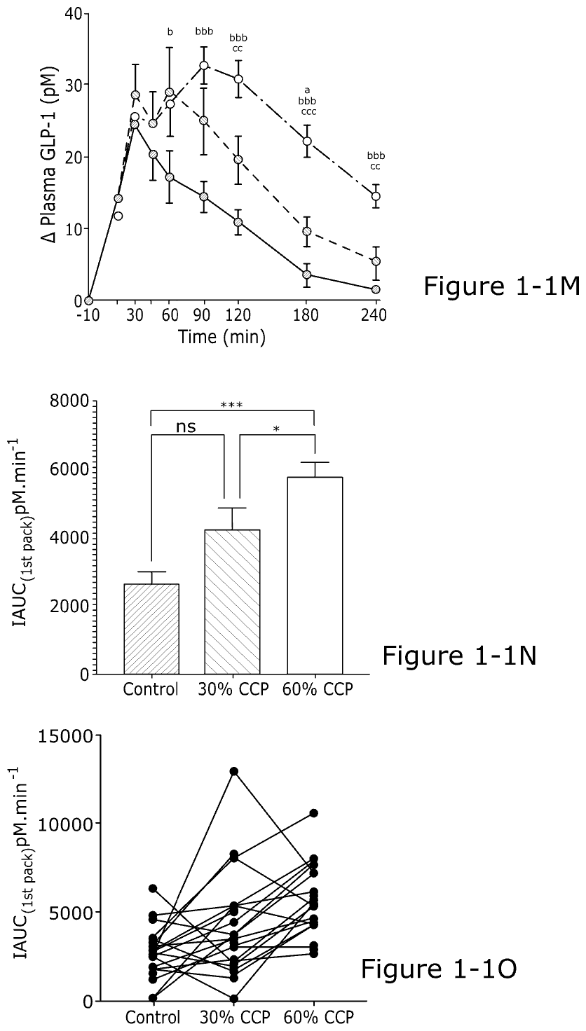

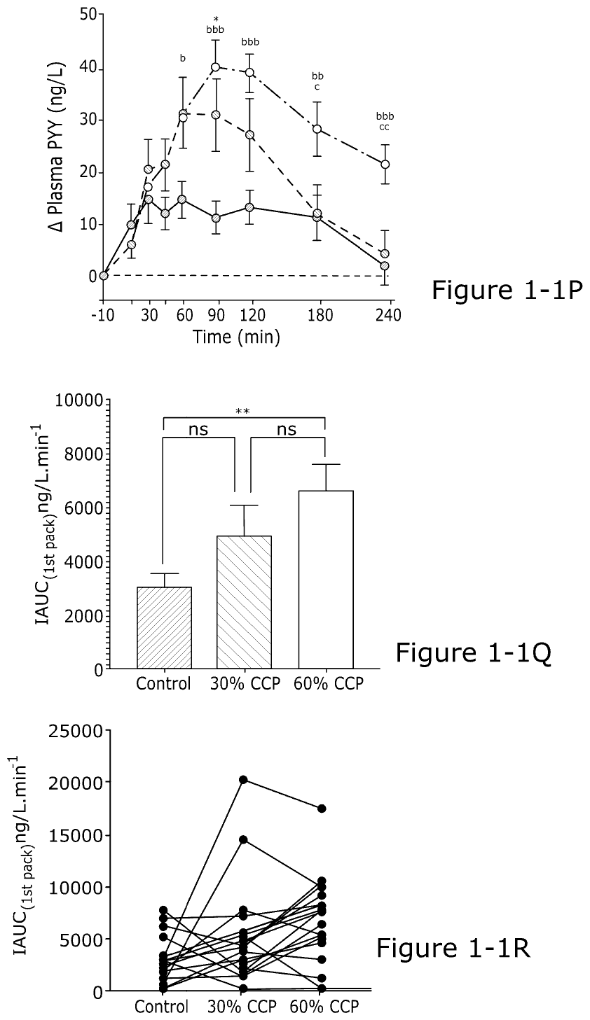

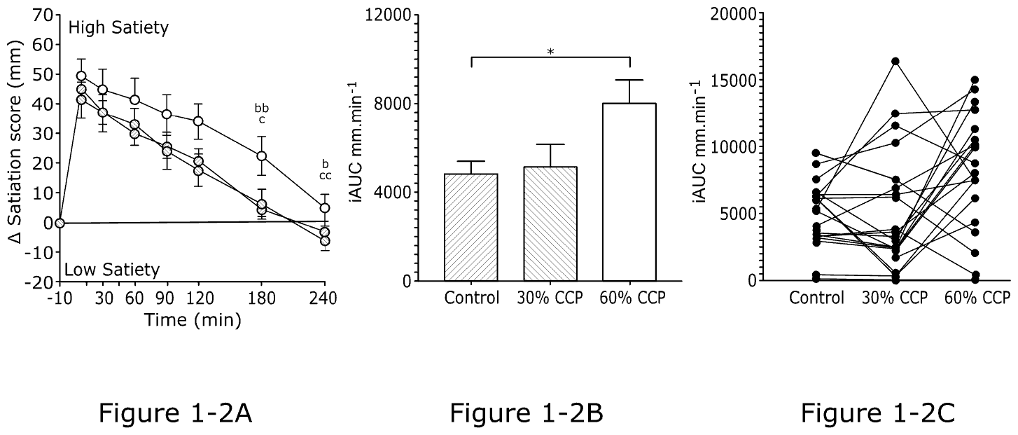

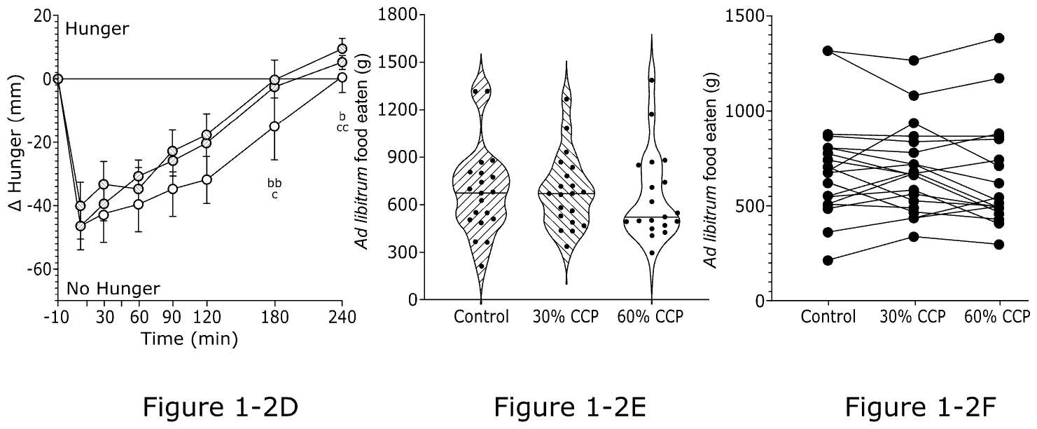

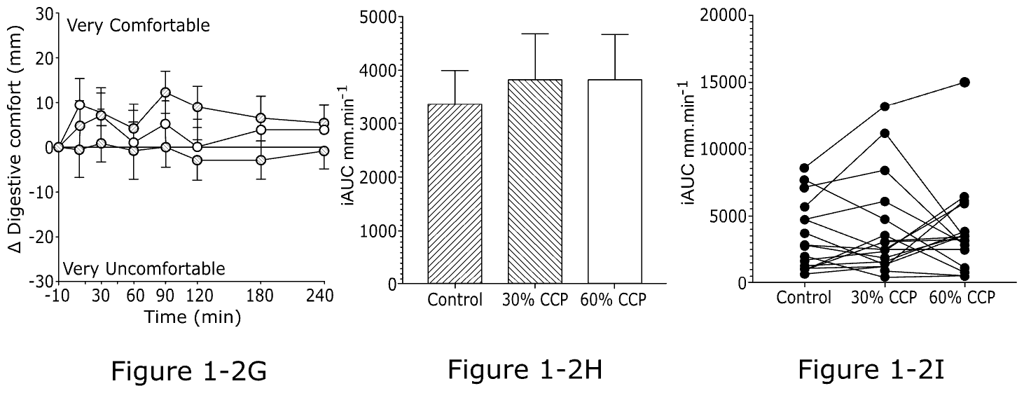

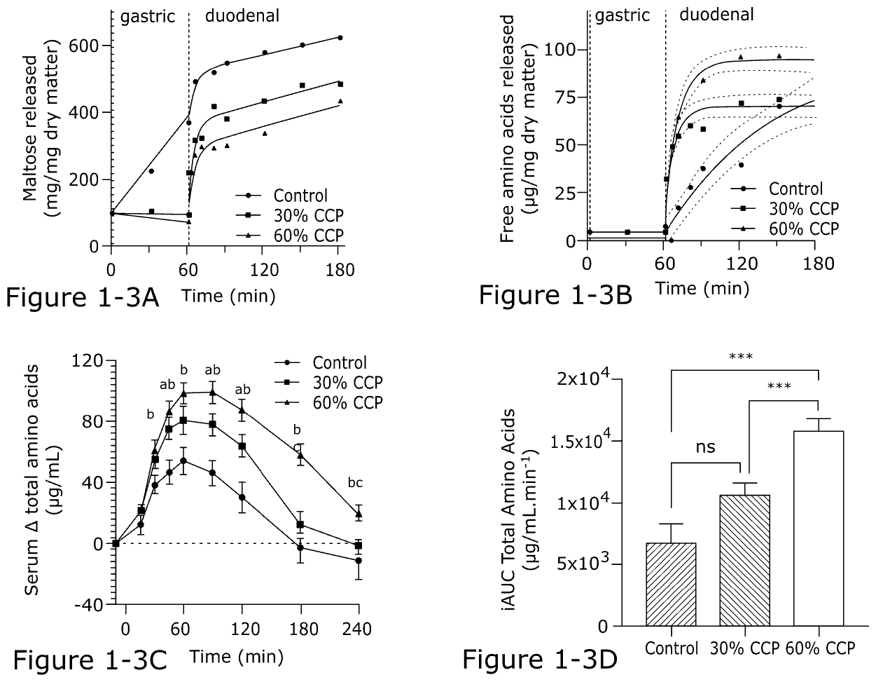

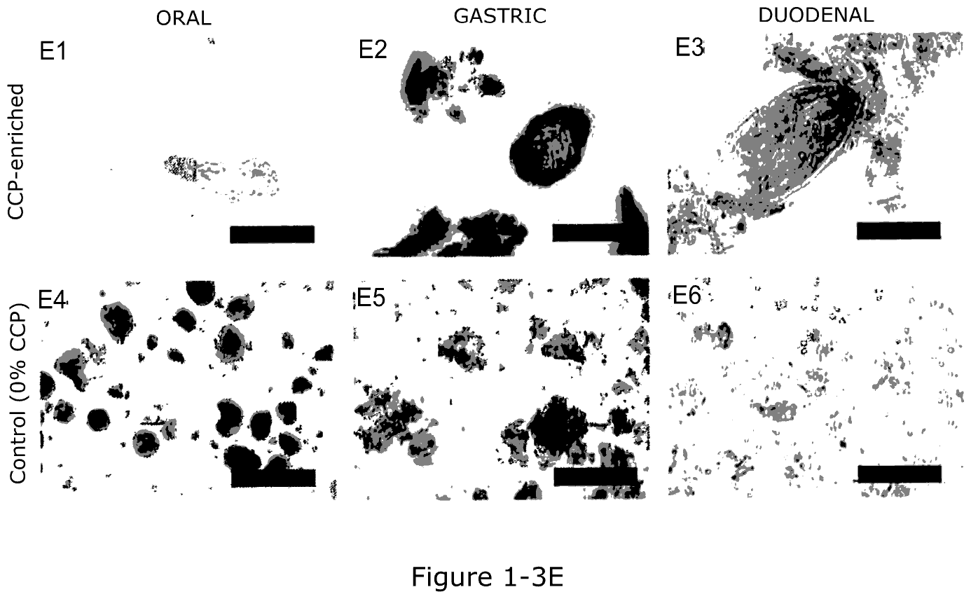

FIG. 1-1 shows glycaemic, insulinaemic and gut hormone responses to control and CCP-enriched test bread. Postprandial responses are based on analysis of blood samples collected following consumption of white bread rolls containing 0% (control, n=20), 30% (n=20) or 60% (n=19) cellular chickpea powder (CPP) and 50 g of available carbohydrate per serving. Time-course data show the change (relative to fasting concentrations) in postprandial plasma glucose (A), insulin (D), C-peptide (G), GIP (J), GLP-1 (M) and PYY (P), measured for 240 min. Bar charts show the integrated area under the curve (iAUC) calculated for the 1st peak for glucose (B), insulin (E), C-peptide (H), GIP (K), GLP-1 (N) and PYY (Q) responses. The scatter plots show the matched iAUC for individual participants for glucose (C), insulin (F), C-peptide (I), GIP (L), GLP-1 (O) and PYY (R) following the consumption of each of the bread types; data points connected by a line were from the same individual. Data presented as means±SEM, significance determined by repeated measures ANOVA; a denotes significantly different between control and 30% CCP, b denotes significantly different between control and 60% CCP and c significantly different between 30% CCP and 60% CCP. For iAUC values; ns p>0.05, *p<0.05, **p<0.01, and ***p<0.001.

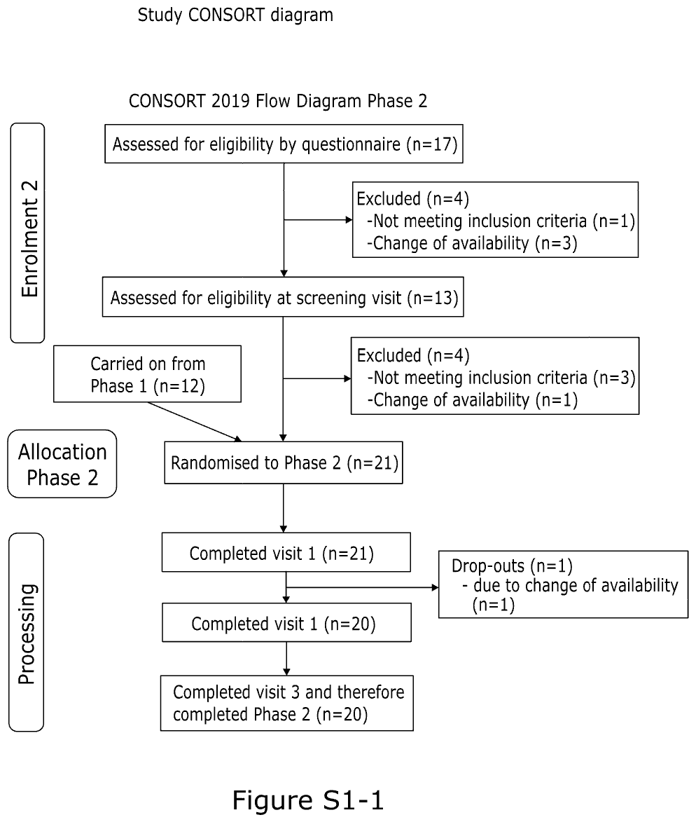

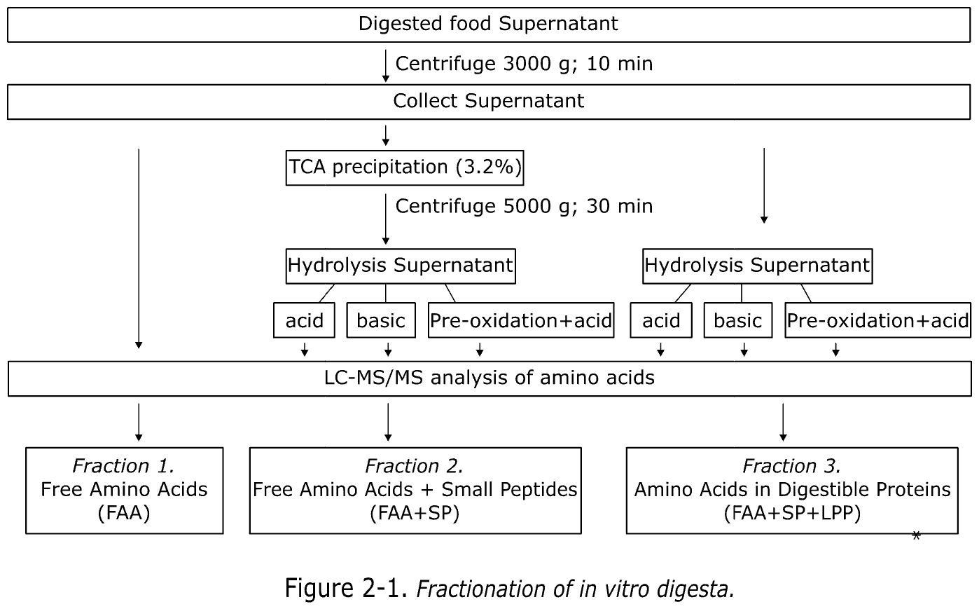

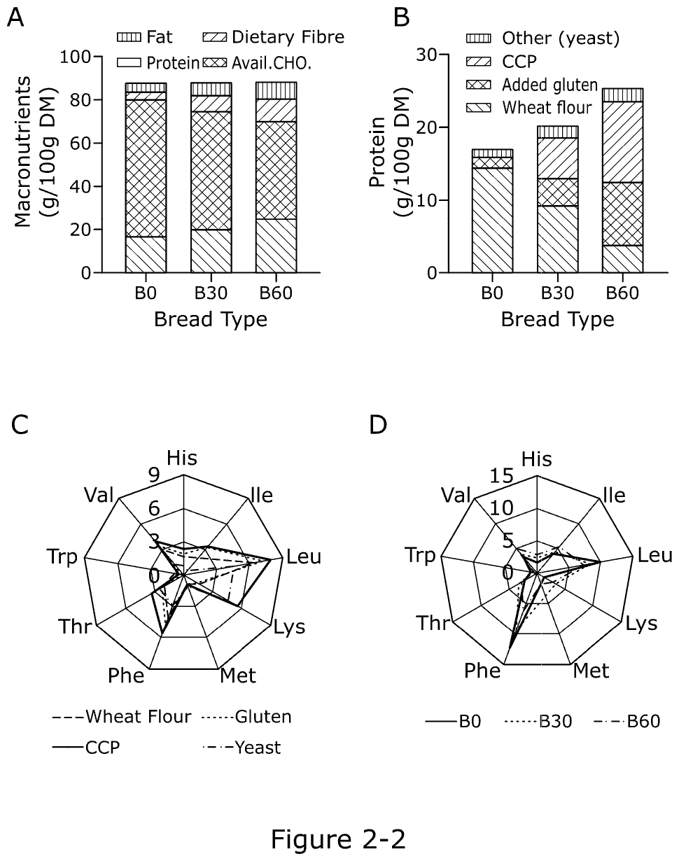

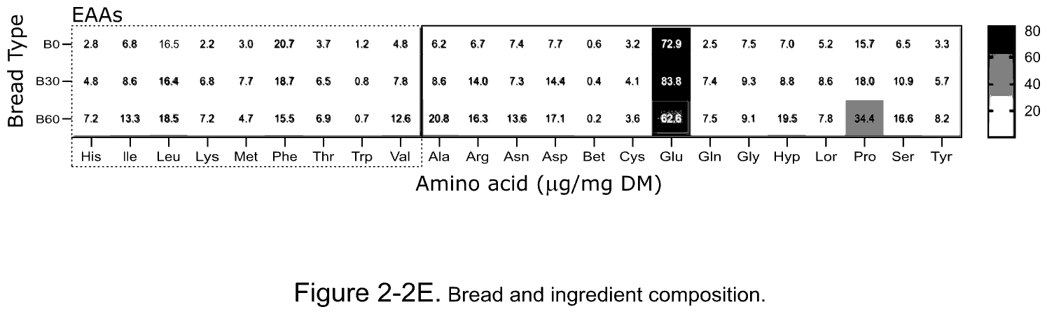

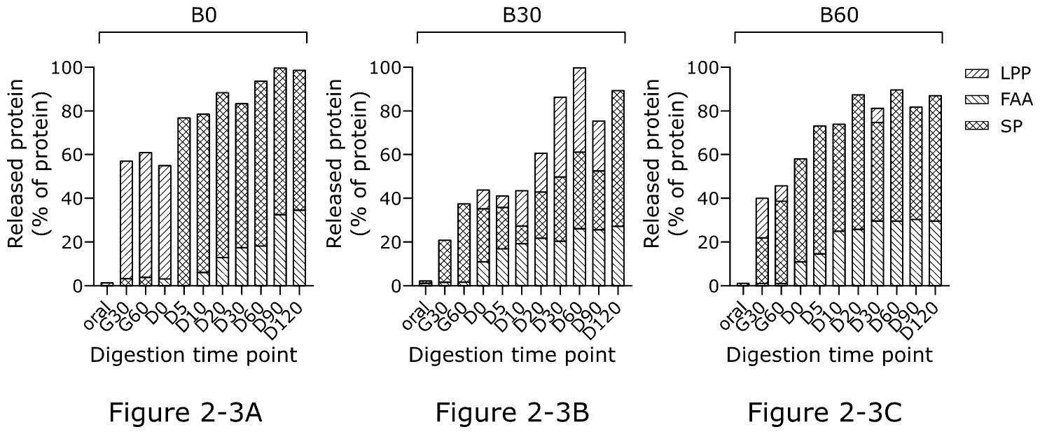

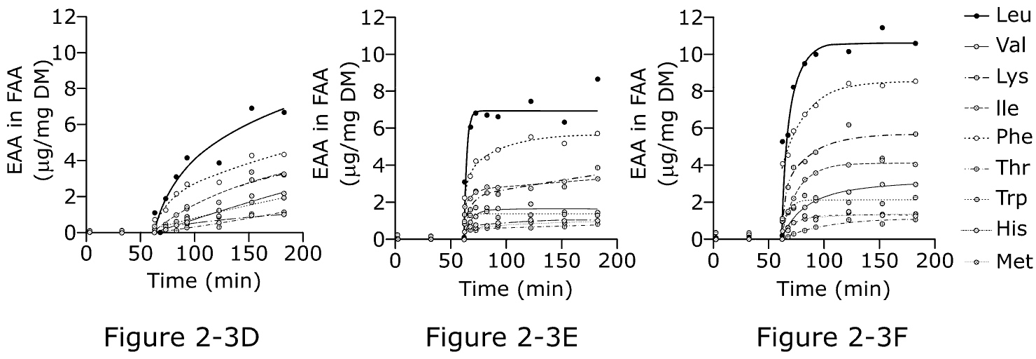

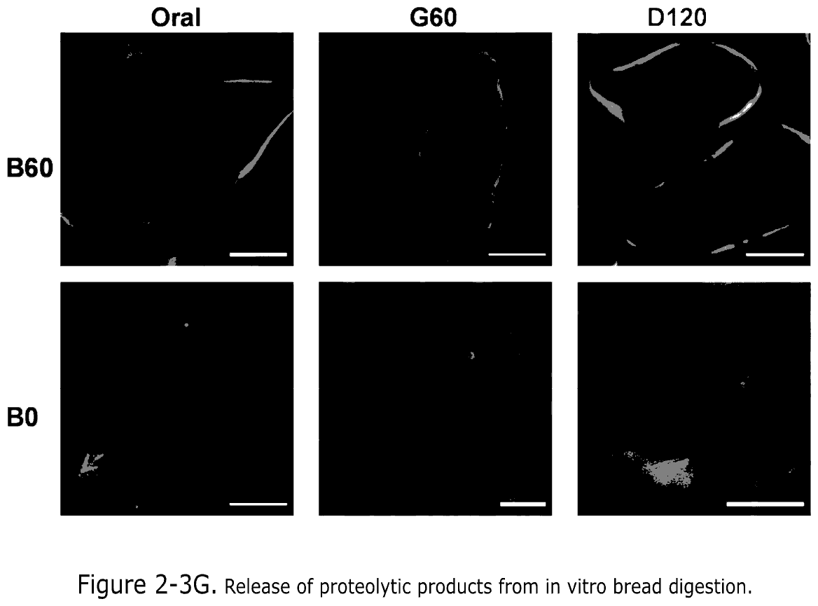

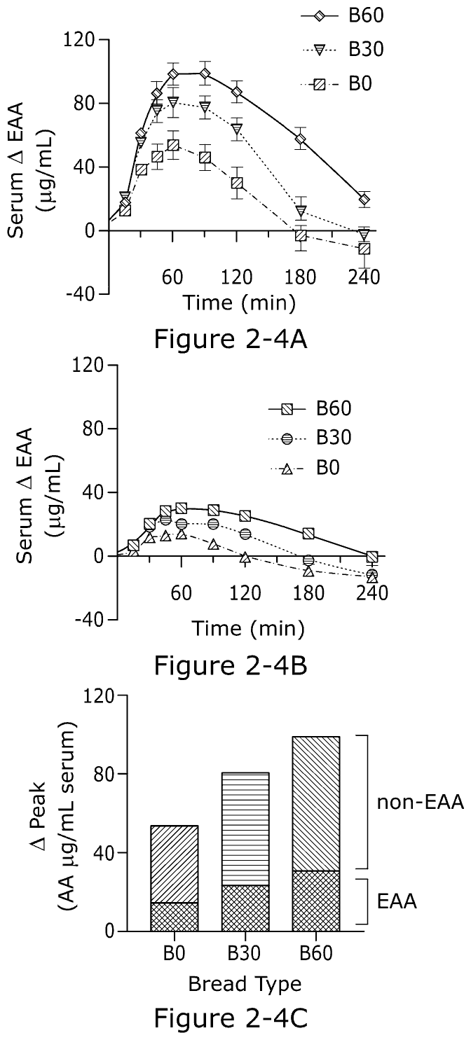

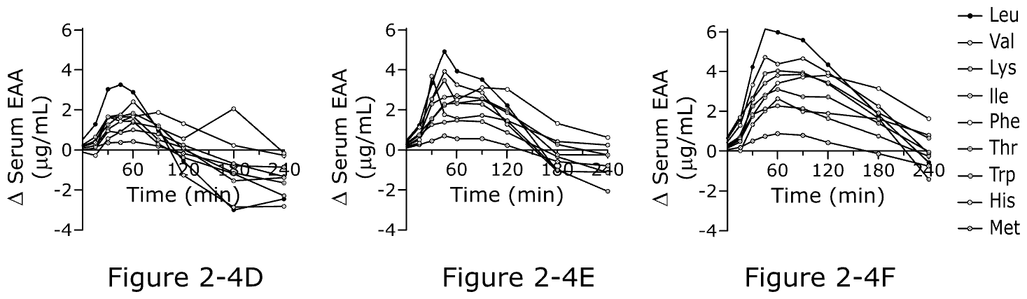

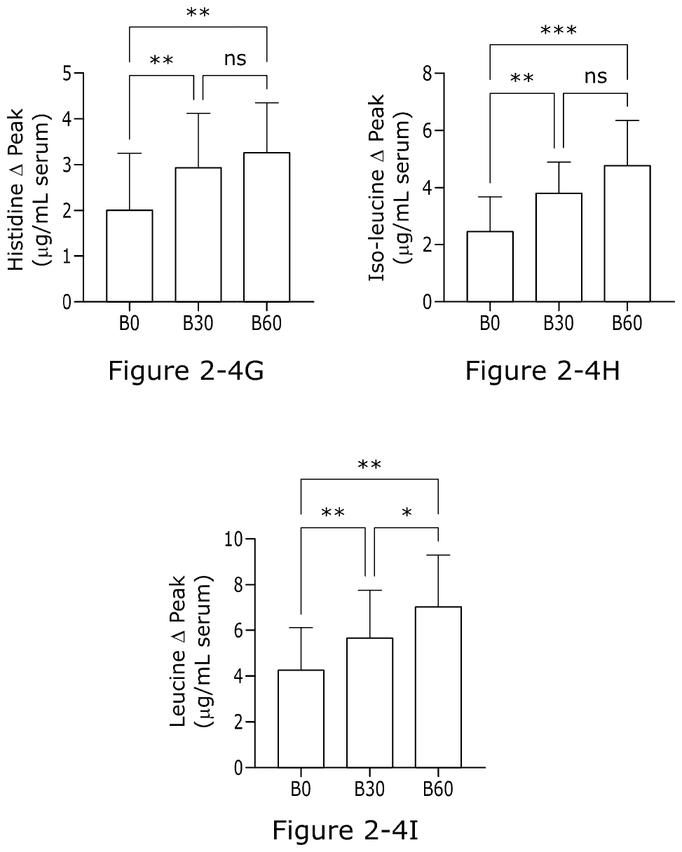

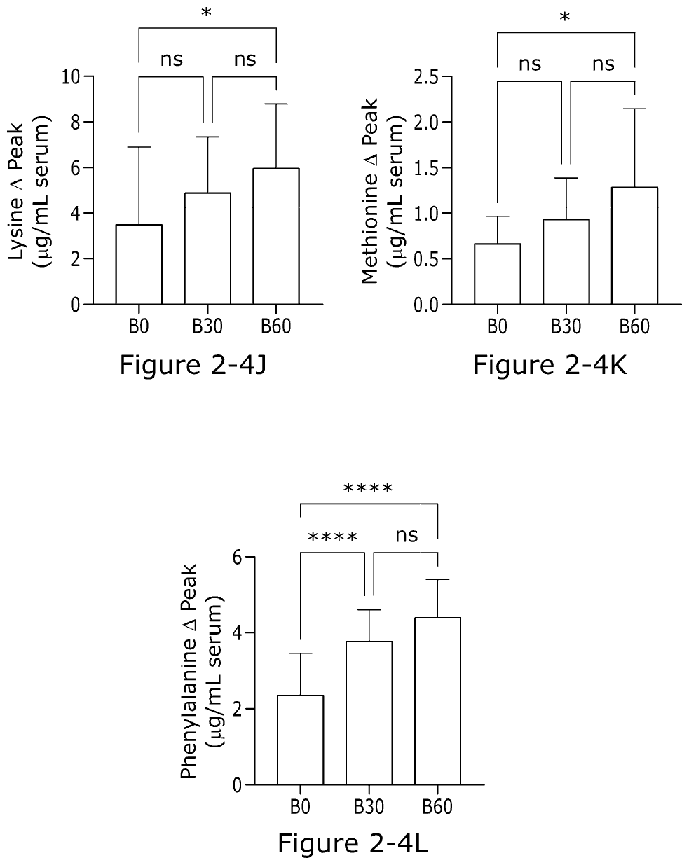

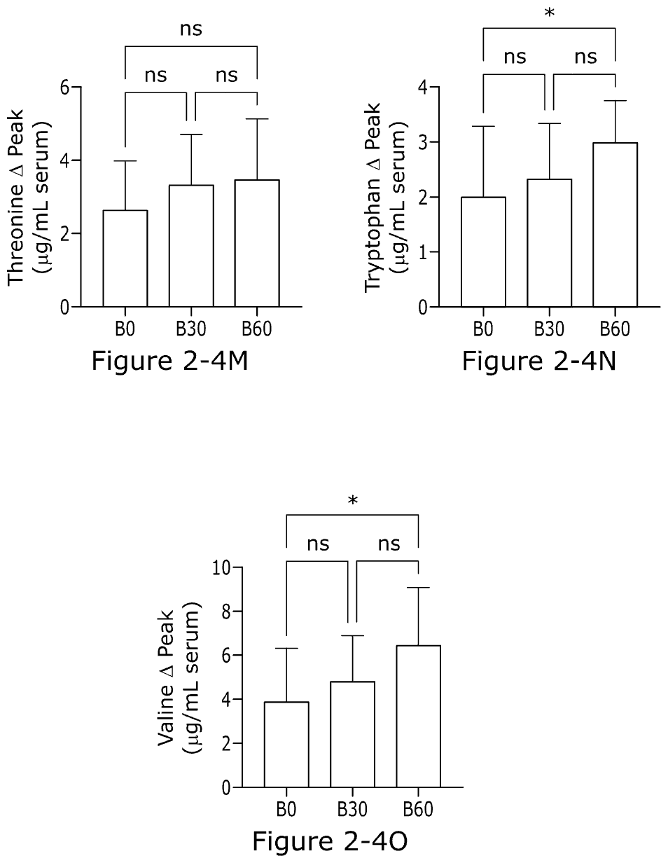

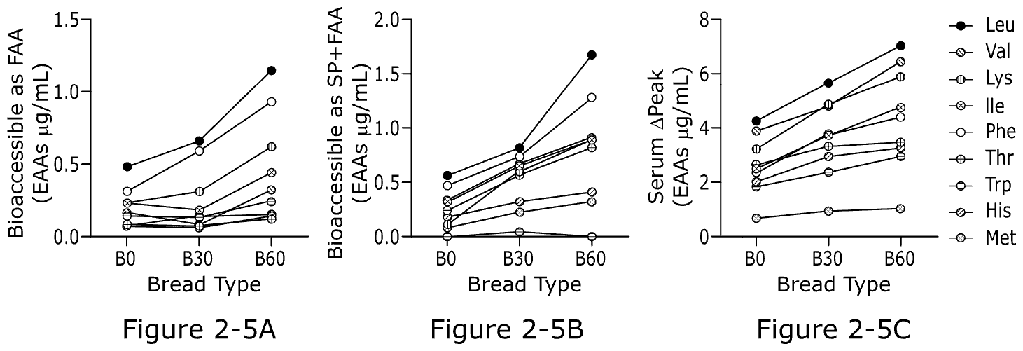

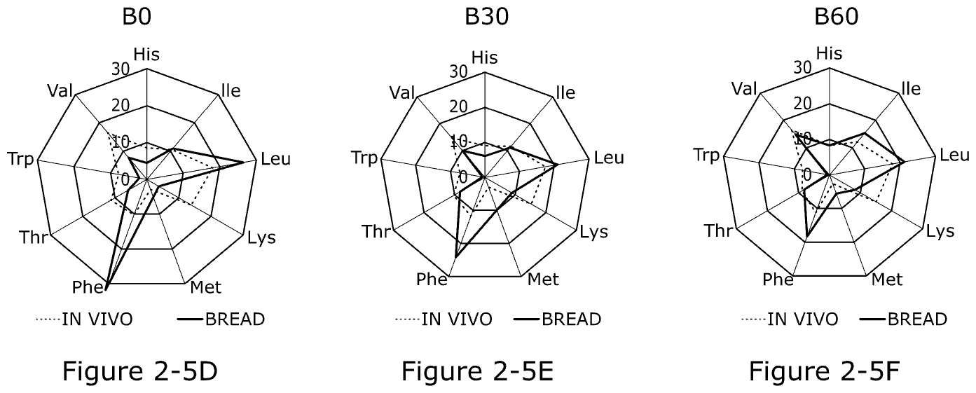

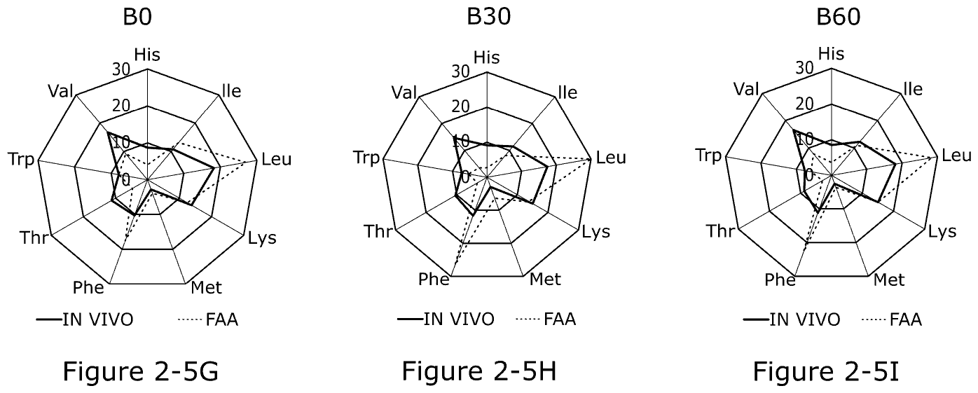

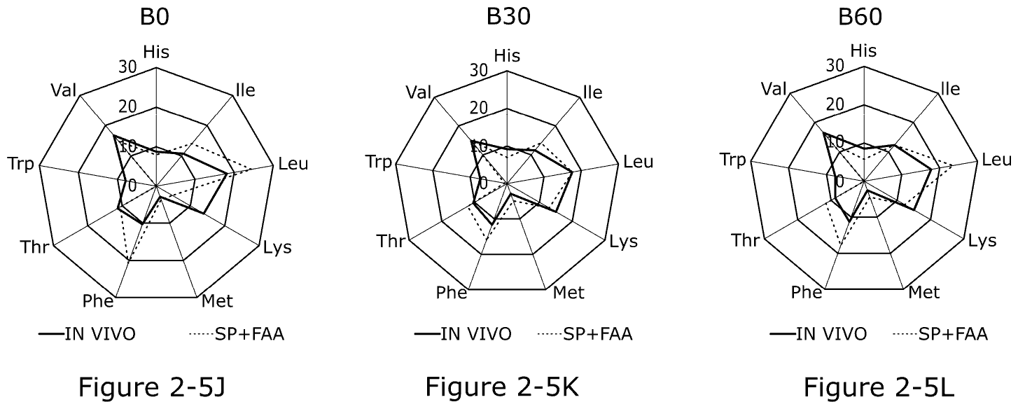

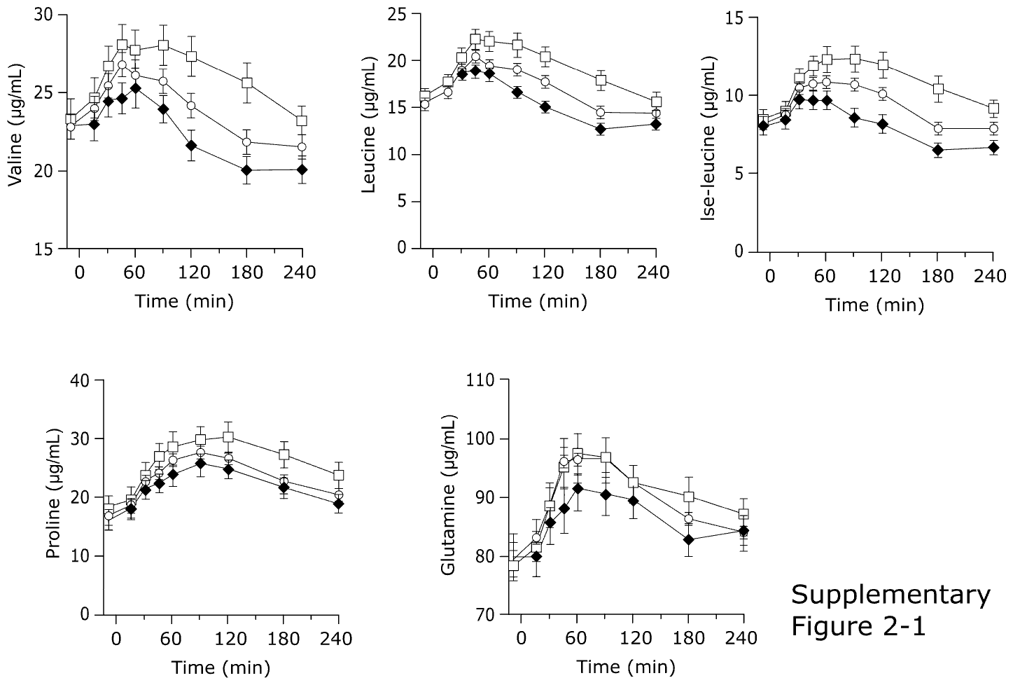

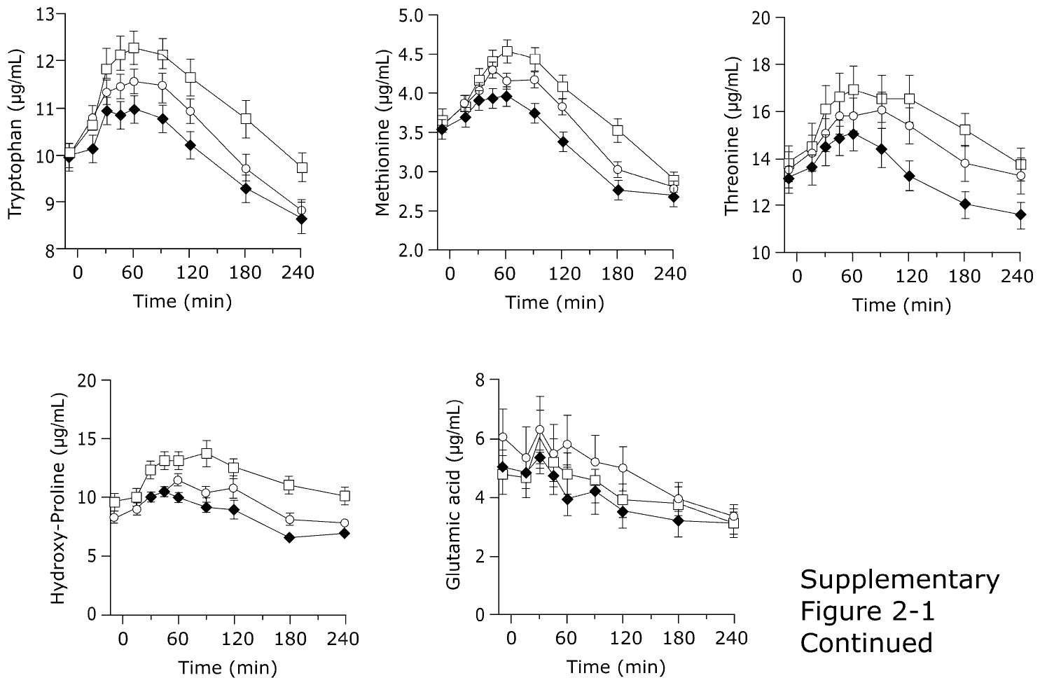

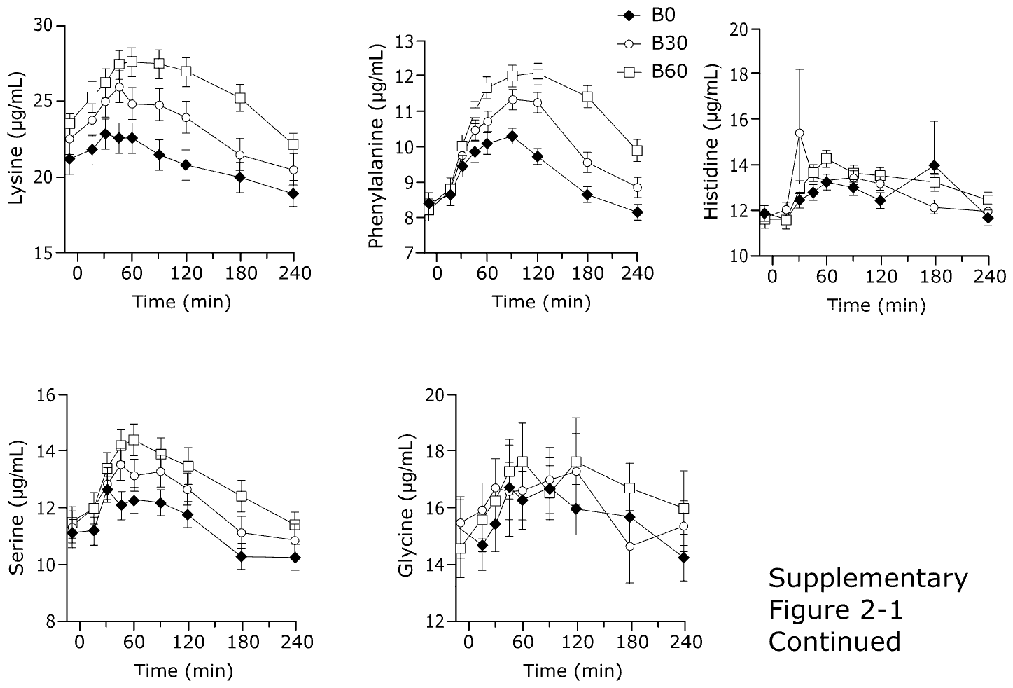

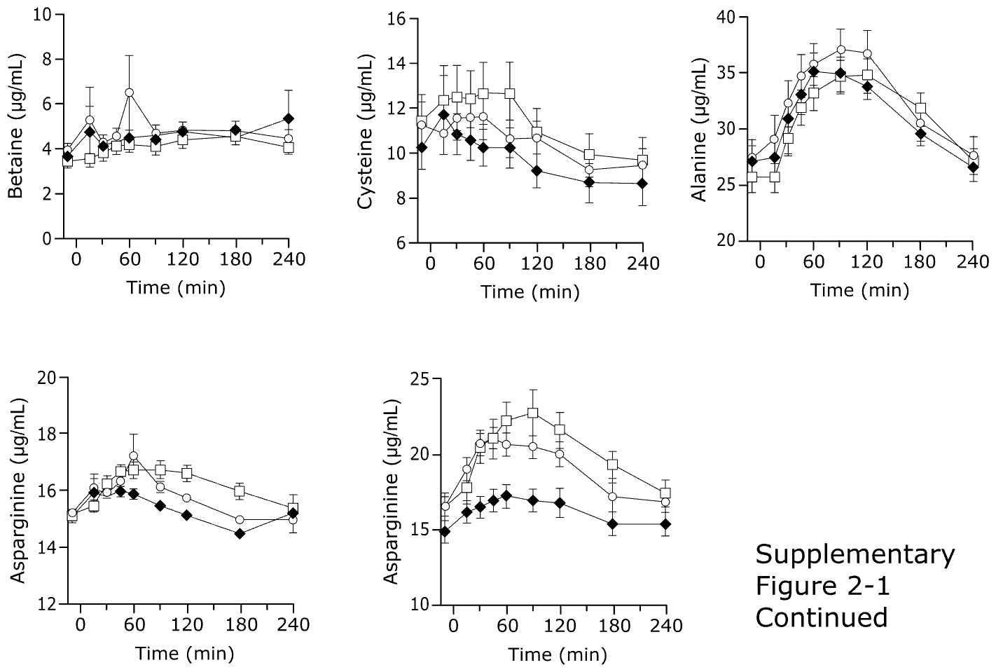

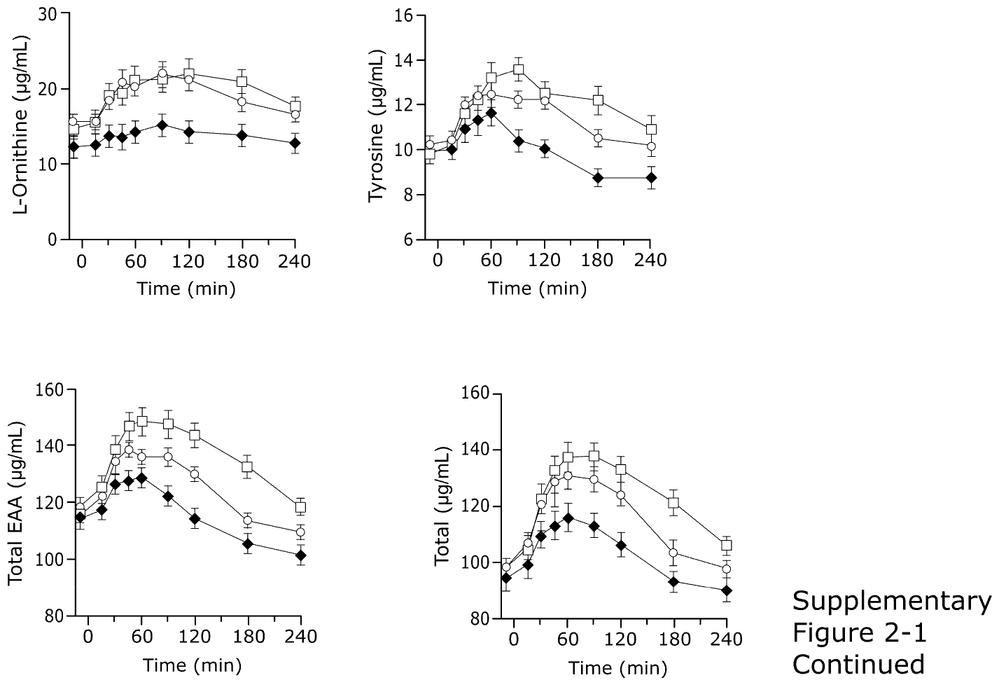

FIG. 1-2 shows the effects of CCP-enrichment on participant satiety and food intake. The change in postprandial combined satiety score (A), hunger (D) and digestive comfort (G) measured for 240 min following consumption of bread rolls, containing 0% (control), 30% or 60% chickpea powder (CPP). The integrated area under the curve (iAUC) calculated for the negative peak of the combined satiety score (B), and total for digestive comfort (H). The matched iAUC for individual participants for combined satiety score (C), and digestive comfort (I) following the consumption of the control and CCP test meals. Changes in the amount of food eaten during a second, ad libitum meal provided to participants after 240 min (E) and comparison within individuals (F) was recorded for control and CCP test meals. Data presented as means±SEM, significance determined by repeated measures ANOV; ^{a}Significantly different between control and 30% CCP, ^{b}Significantly different between control and 60% CCP and ^{c}Significantly different between 30% CCP and 60% CCP. *P<0.05, **P<0.01, and ***P<0.001.

FIG. 1-3 shows the in vitro digestibility, microstructural changes and in vivo serum amino acid responses following ingestion of control and CCP-enriched breads. Digestibility curves show maltose (A) and free amino acid (B) release during in vitro digestion of control (0% CCP), 30 and 60% CCP-enriched breads. Each of the data points in AB is the mean of at least duplicate digestions, with curves fitted by non-linear regression (solid line) to two phase (maltose) or one-phase association (free amino acids) equations, with 95% confidence bands (dashed lines) shown for the latter. In vivo data shows postprandial increases in total serum amino acid concentrations (C) following human consumption of 0% (control, n=20), and 30 (n=20) and 60 (n=19) % CCP breads, plotted over time as means±SEM. Significance determined by mixed-effects ANOVA with Tukey's posthoc test ^{a}Significantly different between control and 30% CCP, ^{b}Significantly different between control and 60% CCP and ^{c}Significantly different between 30% CCP and 60% CCP. Incremental area under the curve (iAUC, mean with SEM) for serum amino acid responses (D); ns p>0.05, *P<0.05, **P<0.01, and *P<0.001. Light micrographs (E), stained with lugol's iodine (E1-6) and toluidine blue (E3, E6) show presence of intact plant cells with encapsulated starch from CCP-enriched breads during oral (E1) and gastric (E2) digestion, with some cell rupture evident at the end of the duodenal phase (E3). No intact cells were present in control bread, and extensive wheat starch granule digestion is evident (E4-E6). Scale bars=100 μm.

FIG. 2-1 shows a diagram of fractionation of in vitro digesta. This approach separates proteolytic products of digestion into fractions containing 1-free amino acids (FAA), 2-FAA and small peptides (SP), and 3-FAA, SP and large polypeptides and solubilised protein (LPP), which are relevant for estimations of AA bioaccessibility. Modified/Adapted method based on (Pälchen et al., 2021).

FIG. 2-2 shows the bread and ingredient composition. Macronutrient composition of bread (A) and contribution of ingredients to bread protein content (B) for breads B0, B30 and B60, in which CCP replaced 0, 30 or 60% (w/w) of wheat flour, respectively. Radar plots show the essential amino acid composition (EAA) of the protein component (mg EAA/100 mg protein) of ingredients (C) and breads (D). Heatmap (E) shows the amino acid content per bread dry matter (DM) for all amino acids measured in each bread type, with darker colour intensity for higher values.

FIG. 2-1 shows the release of proteolytic products from in vitro bread digestion. Stacked bar charts (ABC) show free amino acids (‘FAA’), small peptides (‘SP’) and large polypeptides and proteins (‘LPP’) measured at different time points in the digesta supernatant after oral (‘O’), gastric (‘G’) and duodenal (‘D’) digestion for each bread type (B0, B30 and B60). XY scatter plots (DEF) show increasing concentration of individual EAAs within the FAA fraction with time, and the legend in F applies to DEF. Data points in DEF are overlayed with a trendline fitted for each individual EAA by robust non-linear regression to an exponential two-phase association equation. Confocal images (G) show protein (red) encapsulated within plant cell walls (blue) of CCP (as seen here in B60) or in the surrounding wheat matrix (B0) at different stages of digestion; Oral, -after 2 min oral; G60-after 60 min gastric; D120-after 120 min duodenal digestion. Scalebar 50 μm

FIG. 2-4 shows Postprandial responses (change from fasted baseline) following consumption by healthy humans of breads in which CCP replaced 0, 30 or 60% (w/w) wheat flour (B0, B30 or B60), shown as group mean (n=20 for B30 and B60, n=19 for B60) with SEM for total measured amino acids (A) and essential amino acids (B). Stacked bar chart shows maximum postprandial rise from fasted concentrations (ΔPeak) for EAAs and measured non-EAAs (C). Mean postprandial responses are shown for each EAA and following each bread type in DEF. Bar charts (G-O) show effect of bread type on ΔPeak for each EAA. Significant differences determined by repeated measures ANOVA with Tukey's post-hoc test are annotated as follows; p<0.01*, p<0.05** and p<0.001***, p<0.0001****, ns—not significant.

FIG. 2-5 shows the amount of bioaccessible EAA within the free amino acid (‘FAA’, A) and/or small peptides fraction (‘SPP’, B) of digesta after 120 min of duodenal digestion per bread roll B0, B30 and B60 (as served basis) is shown alongside in vivo EAA Δpeak concentrations (C) measured in human serum (mean of n=20 for B0 and B30, n=19 for B60) after consumption of each bread type (1 roll per serving). Legend in C applies to ABC. Radar plots (D-L) show each EAA as a proportion of total EAA (y-axis=EAA %/total EAAs) measured in vivo (Δpeak, dashed lines), in the bread product (DEF), and released in vitro (solid lines) as either SP+FAA (GHI, calculated as per eqn. 2A) or FAA (JKL, calculated as per eqn. 2B) and resolved by bread type; B0 (DG), B30 (EH) and B60 (FI).

Supplementary FIG. 2-1 Shows mean human serum amino acid responses following consumption of CCP-enriched breads by healthy human participants. Figures within the red box are the 9 EAA. Values are mean with error bars as SEM, n=20 for B0 and B30, n=19 for B60, legend applies to all panels.

### RESULTS

### Protein Content and Amino Acid Composition of Ingredients and Bread Products

Protein content and amino acid composition of ingredients and bread products is shown in FIG. 2.

The macronutrient composition of bread products is shown in FIG. 2-2A. The control wheat bread (B0) contained 17.0 g protein/100 g DM, and replacing 30 or 60% (w/w) of the wheat flour in the formulation with PulseON® increased the protein content to 20.2 and 25.5 g protein/100 g DM for B30 and B60 respectively (protein by Dumas method, N×6.25, data supplied by ALS). These values were consistent with our in-house calculation of protein content from analysis of total N of the bread products (17.1, 20.1, and 23.8 g protein/100 g DM for B0, B30 and B60, respectively) and within 5% theoretical values calculated from the ingredient composition. Protein (17 KJ/g) accounted for 16.8, 20.0 and 25.3% of the total energy value in B0 (1715.2 KJ/100 g DM), B30 (1712.1 KJ/100 g DM) and B60 (1710.2 KJ/100 g DM), respectively. White wheat flour (17.1 g protein/100 g ingredient DM), PulseON® (20.3 g protein/100 g ingredient DM) and added wheat gluten (83.6 g protein/100 g ingredient DM) were the main ingredients of the bread recipes and the main protein source in the bread products, with a remaining <7% of protein coming from yeast and other sources (FIG. 2-2B).

From our analysis of the EAA composition of these ingredients, we estimate that the proteins in the CCP (PulseON® powder) contained a higher proportion of EAAs (˜33.5% EAAs) compared with wheat protein in white wheat flour (22.0% EAAs) and gluten (25.2% EAAs). The EAA composition (% of total protein basis) of ingredients is shown in the radar plot, FIG. 2-2C. Compared to the wheat proteins, PulseON® protein contained higher proportions of all other EAA, with exception of methionine and tryptophan which were a minor component of all ingredients. In the CCP (PulseON®) ingredient, Leucine, Lysine, and Phenylalanine were the EAAs present in the highest amounts. Wheat flour was also high in Leucine, but low in Lysine. In the breads, EAAs accounted for ˜29, 28 and 27% of total AAs in B0, B30 and B60, and the AA composition reflected that of the ingredients (FIG. 2-2D, radar plot). Replacing bread wheat flour with CCP and gluten increased the total EAA and non-EAA content (FIG. 2-2 E).

FIG. 2-3 shows the appearance of proteins and proteolytic products in the digesta following in vitro digestion of each bread type. In all bread products, a rapid release of protein occurred during the early gastric phase; This process occurred more rapidly and to a greater extent in in the control bread (B0, FIG. 2-3A) than in the chickpea-enriched breads (B30 and B60, FIGS. 2-3B and C). At the end of the gastric phase (60 min), 61% of the initial protein in B0 had been released from the food matrix, but was still mostly in the form of large proteins or polypeptides. For B30 and B60, the hydrolysis of the proteins in the gastric phase was lower accounting for 38 and 46% of the total protein respectively, but here the released protein was mainly in the form of small peptides, with very low amounts of free amino acids released.

In the duodenal phase, the amount of small peptides and free amino acids in the digesta increases for all bread products. The most rapid rate of change occurred within the first 20 min of meal exposure to duodenal conditions. The release of free AA in the small intestine is quicker in breads containing chickpea powder compared to breads made only with wheat flour, reaching stable values in B60 and B30 after 60 min of intestinal digestion whereas B0 followed a slower and lower production of AAs. With the curve beginning to approach a plateau from around 90 min. At the end of the duodenal digestion, ˜99% of the protein from B0 had been released and digested into small peptides (65% of initial protein), and free amino acids (34% of initial protein). For B30 and B60, ˜90, and 88% of the protein had been released and digested into small peptides (˜62%, 58%) and free amino acids (˜28%, 30%). This implies a lower release, solubilisation and/or digestibility of protein in the chickpea-enriched breads.

The release of free essential AA was followed during the digestion at different time points (FIG. 2-3 DEF). With the exception of tryptophan the levels of the other free essential AA released at the end of the oral and gastric phase were negligible (0.10; 0.20 and 0.34 ug tryptophan/mg dried bread were released at the end of oral phase in B0, B30 and B60). However, as soon as the digesta entered the in vitro duodenal phase, the presence of the nine essential amino acids released into the aqueous digesta started to increase. At D120 the amounts of free Phe, Leu and Lys increased with the increasing content of chickpea powder in composition of the breads. The release of ILeu, Met and His was a bit lower in B30 and B60 than in B0, whereas Val, Thr and Try were released at slightly lower amounts in B30. Overall, bread B60 released more free essential amino acids than the other two breads, only matching values of threonine in B0.

Based on the sum of amino acids present within small peptides and free amino acids fraction, ˜99, 90 and 88% of the total AAs in B0, B30 and B60 could be considered bioaccessible. A similar effect was observed with regard to the total N analyses, which showed that 96, 97 and 93% of total N in B0, B30 and B60 had been released at the end of the duodenal digestion. Our data are also consistent with confocal imaging of bread samples collected from the oral, gastric and duodenal digesta (FIG. 2-3G) revealed a high proportion of cell wall encapsulated protein within breads containing CCP during oral and gastric digestion, but after 120 min of duodenal digestion, this encapsulated protein was no longer apparent within the cells.

Thus, a high proportion of the EAAs and N that constitutes the encapsulated CCP protein appears to be digested and released from the food matrix as SP and FAA within 2 h of duodenal digestion. Consequently, replacing wheat flour with encapsulated chickpea protein (CCP) resulted in higher amounts of bioaccessible EAAs.

FIG. 2-4 shows the mean total AA (FIG. 2-4A) and EAA (FIG. 2-4B) serum concentrations measured during the postprandial period after each bread type. EAAs accounted for ˜27, 29 and 31% of the postprandial rise in total serum AA for B0, B30, B60 at ΔPeak (FIG. 2-4C).

The highest total amino acid concentration was most commonly observed at 60 min, regardless of bread type. However, there were some different temporal patterns for individual amino acids (FIG. 2-4. DEF), for example, phenylalanine tended to peak later than 60 min while leucine peaked earlier, while lysine tended to peak later with higher CCP-content.

The maximum postprandial increase in serum EAA concentrations (ΔPeak) differed significantly between bread types. Total AA were 49 and 83% higher following the B30 and B60 compared to the control. At an individual amino acid level (FIG. 2-4C), ΔPeak for Leucine increased significantly with increasing dose of PulseON®; iso-leucine, phenylalanine and histidine were significantly higher for PulseON enriched breads compared with the control bread, but the difference between 30 and 60 was ns. For lysine, valine, tryptophan and methioinine ΔPeak for B60 was significantly higher than the control. ΔPeak for threonine was ns. between bread types. Postprandial responses for each individual amino acids (non EAA and EAA) is shown in Supplementary FIG. S2-1.

### In Vitro-In Vivo Comparisons

The serving-size adjusted bioaccessible EAAs are shown for each EAA in FIG. 2-5 alongside Δpeak EAA concentrations measured in human serum following consumption of the same bread rolls. For the in vitro data, EAAs within the FAA fractions would be expected to be bioavailable, however it is also possible that the EAAs within the small peptides would rapidly become bioavailable (e.g., through the action of brush-border peptidases that are not represented in the simulated digestion procedure). The FAA (FIG. 2-5A) and FAA+SP (FIG. 2-5B) fractions were therefore plotted separately for comparison of these to human serum levels of absorbed EAAs (FIG. 2-5C). The EAA profile of the bread products (FIG. 2-5DEF) was weakly correlated with the in vivo serum EAA profile (Pearson's r=0.467, p=0.014). There was a significant positive correlation between EAA profiles of in vitro digesta and in vivo serum, with tendency for serum levels to be slightly better correlated to the in vitro data when EAAs within the small peptide fraction (FIG. 2-5. JKL were included in the comparison (i.e. considered bioavailable) (Pearson's r=0.725, p<0.001), than when only EAAs within the FAAs were considered (FIG. 2-5 GHI) (Pearson's r=0.607, p<0.001).

Overall, there was good agreement between bioaccessible EAAs measured within the in vitro digesta and the serum EAA responses seen in vivo, regardless of bread type.

Food microstructure is an important regulator of nutrient bioavailability and can be exploited to improve cardiometabolic health. Here we show the effects of replacing wheat flour (ruptured plant cells) with a novel cellular flour on postprandial gut hormones, glucose, insulin and satiety responses to white bread. We found that consumption of bread containing intact plant cells elicited significantly elevated and sustained release of anorexigenic hormones (GLP-1, PYY), increased fullness, and attenuated glycaemia in healthy humans compared to the control. Our in vitro studies revealed slow digestive breakdown of intact plant cells and provide a mechanistic explanation for the physiological effects observed. Thus, the novel use of intact plant cells to replace refined flours in a processed food stimulates an anorexigenic response and has potential applications in body-weight management and cardiometabolic risk.

Replacement of wheat flour with legume cell flour resulted in significantly elevated and sustained release of gut hormones, increased satiety, and attenuated postprandial glycaemia. In vitro digestions indicate the mechanism by which dietary fibre (plant cell wall integrity) influences starch and protein bioaccessibility. The novel use of intact plant cells to replace refined flours in processed foods, stimulates an anorexigenic response and has potential benefits on body-weight management and cardiometabolic risk.

Here we present for the first time data showing the gut hormone and satiety responses in healthy humans to wheat bread (white) enriched with intact leguminous cellular structures. The gut hormone responses are thought to be mainly driven by gut-mediated signalling, so the findings are presented together with new in vitro digestion data from the INFOGEST 2.0 protocol (Brodkorb, Egger, Alminger, Alvito, Assunção, Ballance, Bohn, Bourlieu-Lacanal, Boutrou, Carrière, et al., 2019) to gain further insight into the luminal release of digestion products (sugars and free amino acids) from these novel food matrices. Our findings provide evidence of a new mechanism by which dietary fibre structure influences enteroendocrine-mediated appetite regulation. The novel cellular flour studied provides opportunities to develop a next generation of satiety promoting processed foods for obesity management. White bread, which is consumed by most British households on a daily basis (Lockyer & Spiro, 2020), was used in this study as an exemplar food vehicle, and is therefore an important target for delivery of enhanced dietary fibre content with satiety promoting potential.

Food microstructure is an important regulator of nutrient bioavailability and provides an accessible strategy for improving the metabolic stasis in health and disease. Supplementation of wheat flour with intact legume cells on postprandial gut hormone (GLP-1, PYY and GIP), appetite, glucose and insulin responses was investigated in healthy humans (n=20). Venous blood was collected following consumption of bread rolls containing 0, 30 or 60% cellular legume flour. Starch and protein bioaccessibility of the test breads were studied under simulated digestive conditions.

Additionally, our studies demonstrate, for the first time, the effect of encapsulated legume protein enrichment of white wheat bread on bioaccessibility and bioavailability of EAAs. Encapsulated legume proteins in CCP-enriched breads were found to be digested into bioaccessible small peptides and free amino acids during simulated duodenal digestion. The EAA within these fractions of in vitro digesta was strongly correlated to the postprandial rise in serum EAAs following human consumption of CCP-enriched breads. Together, these findings indicate that the digestion of encapsulated legume protein liberates EAAs that are both bioaccessible and bioavailable. Thus, CCP-enrichment of white wheat bread improved their protein quality.

White wheat bread is a staple-food in many households worldwide and is therefore an appealing food vehicle for influencing nutritional status of the general public. Enrichment of wheat bread with pulses provides a route to enhancing the protein and dietary fibre intakes. Using novel cellular pulse flours, makes it possible to also lower the bread's glycaemic potency significantly, however, such ingredients require the protein and starch to be encapsulated by the cell wall, and the implications for bioavailability of EAAs during digestion had not yet been studied.

Here we show that CCP-enrichment of white wheat bread products improved the amount and types of bioaccessible and bioavailable EAA, even though the legume protein was encapsulated in the plant cells. The improved EAA profile of the CCP-enriched bread product were both due to the higher protein (and therefore total amino acid-) content of the CCP-enriched bread compared to wheat bread, and the higher ratio of EAA:non-EAA within the legume compared to cereal protein. Although the additional protein contributed by the CCP was encapsulated by cell walls at the time of ingestion, a nutritionally significant proportion of EEAs become bioaccessible in the form of small peptides and free amino acids released by action of proteolytic enzymes (e.g. trypsin) in the duodenum; this was reflected in the significantly higher serum EAA concentrations following human consumption of the CCP-enriched breads. Thus, the higher release of EAAs from CCP-enriched bread suggests that some intracellular protein hydrolysis is occurring, with smaller digestion products becoming bioaccessible and subsequently absorbed.

Not all the EAAs with the CCP-enriched bread products were bioaccessible, however; After 2 h of simulated duodenal digestion, we estimated that around 10-12% of the EEAs in B30 and B60 were still trapped within inaccessible/undigested proteins. These breads contained a combination of wheat and CCP-derived protein, but considering that ˜99% of EAAs within wheat protein were found to be bioaccessible (as seen in B0), it seems likely that the inaccessible protein was associated with CCP component. This would suggest around ˜27-34% of the CCP protein to be inaccessible, and falls within the range of digestibility estimated for cooked cellular legume material in previous studies (Melito & Tovar, 1995). The inaccessible fraction could be entrapped or intrinsically resistant to digestion by mammalian enzymes (Duijsens et al., 2022).

Another important aspect of our studies was the comparison of in vitro estimates of bioaccessible EAAs to serum EAA concentrations for the same bread products. The INFOGEST digestion model, used here, has been designed to simulate the biochemical and enzymic conditions of the human small intestinal lumen (Brodkorb, Egger, Alminger, Alvito, Assunção, Ballance, Bohn, Bourlieu-Lacanal, Boutrou, & Carrière, 2019), however it lacks brush-border peptidases which further digest small peptides. By comparing the EAA profiles of the free amino acid and small peptide fractions with serum responses, we found that inclusion of the EAAs within the small peptide fraction provided a better correlation to postprandial serum EAA concentrations.

Performing these investigations on bread products allowed for important in vitro-in vivo comparisons and were highly relevant to real-life product applications of a novel food ingredient, however the complexity of the bread matrices limited depth of interpretation. Further mechanistic structure-function studies of proteolytic products released from isolated legume cells would therefore be a logical next step to complement the work presented here.

With regard to product applications, the commercial development of novel cellular pulse flours as functional food ingredients is gaining traction, and there is increasing evidence for and understanding of their nutritional advantages over conventional pulse flours (i.e. in which the plant cells have been destroyed) (Edwards, Ryden, Pinto, van der Schoot, Stocchi, Perez-Moral, Butterworth, Bajka, Berry, & Hill, 2020; Verkempinck et al., 2020; Xiong et al., 2022). In B30 and B60 bread products studied here, the protein accounted for 20 and 25% of energy value of the food, and both would quality for a ‘high protein’ claim as defined by European Commission. In our previous studies, these bread products were also found to produce significantly lower glycaemic responses and prolonged satiety responses compared with wheat flour (Bajka et al., 2021), and provide more than double the amount of dietary fibre per serving of wheat bread, while having product quality characteristics (texture, sensory etc.) that were acceptable to study participants. Thus, enrichment of bread and other bakery products with novel cellular pulse flours represents a promising and tangible opportunity to improve nutritional status and cardiometabolic and gut health of the population.

### Results:

### Human Postprandial Study

A randomised double-blind crossover trial was conducted, in which healthy human participants (Table S1) consumed bread rolls (50 g starch per serving) made with 0, 30 or 60% cellular chickpea powder (CCP) (Table 1) while cannulated to enable meal effects on postprandial gut hormone responses, glycaemia and subjective satiety to be assessed. Out of the 21 participants recruited, 20 completed the study (S1 consort diagram); however, one of the volunteers was unable to provide venous blood samples following consumption of one of the test meals (n=20 for control 0% and 30% CCP, n=19 for 60% CCP).

### Intact Plant Cells Lowered Postprandial Glycaemia and Insulinaemia

Blood glucose, insulin and C-peptide concentrations following ingestion of each of the three bread types (0, 30 and 60% CCP) were compared to assess how enrichment with intact legume cells (in ‘CCP-enriched’ bread) affected the postprandial glucose and insulin responses to bread.

Postprandial plasma glucose responses (FIG. 1-1A-C) were found to be significantly lower (p<0.001, ANOVA) following the consumption of the test bread rolls enriched with 30% or 60% CCP, compared to the control (0% CCP) bread. The glycaemic responses to both CCP-enriched breads were statistically similar irrespective of CCP dose (main effect on glucose at 30 vs. 60% CCP ns, p=0.832, Tukey's test). Analysis of time-series data (FIG. 1-1A) revealed that effects of CCP-enrichment are most pronounced during the early postprandial period (i.e. the first 60 min), with both CCP-enriched test breads eliciting a lower rise in blood glucose than the control bread. Peak glucose concentrations (Cmax) were reached at ˜30 min and were significantly lower (p<0.001) for both CCP-enriched breads, relative to the control (Table 1). Incremental area under the curve (iAUC, 1st peak above the fasted baseline) for glucose (FIG. 1-1B) were >40% lower following the CCP-enriched breads compared with the control; these differences from the control were statistically significant at 30% CCP dose (p=0.008) or close to significance at 60% CCP (p=0.096). From the individualised iAUC glucose data (FIG. 1-1C) it is clear that for most individuals, there was a general trend towards lower plasma glucose with increase in CCP content of the breads, but that the overall effect is skewed by inclusion of data from 3 participants who had a larger glucose response to the 60% CCP bread.

Thus, overall our data shows that substitution of 30% wheat flour with CCP was sufficient to lower the glycaemic response to bread, with no further attenuation at the higher level (60%) of CCP inclusion. Substitution of 60% of the wheat flour with CCP (intact plant cells) resulted in overall significantly lower postprandial insulin (FIG. 1-1D-F) and C-peptide (FIG. 1-2G-I) responses compared with the control bread (p<0.001). These main effects of CCP-enrichment on postprandial insulinaemia were due to the lower plasma insulin and C-peptide concentrations within the first 90 min after ingestion of 60% CCP bread compared with the control bread. Insulin iAUC values (FIG. 1-1E) were 40% lower and peak concentrations were 28% lower after the 60% CCP bread compared with control (p<0.05). Regardless of the type of bread consumed, the plasma insulin concentrations peaked between 30 and 40 min and returned to fasted levels within 180 min. Circulating levels of C-peptide (FIG. 1-1G-I) reflected the observed differences in insulin and peak areas, and mean iAUC for C-peptide responses were 33% lower when participants consumed the 60% CCP bread compared with the control (p=0.009). Insulin and C-peptide responses to breads enriched with only 30% CCP were not significantly different from responses to the control bread (main effects of meal×time interaction, p>0.05 for 0 vs. 30%).

### Intact Plant Cells Produced a Sustained Release of GIP, GLP-1 and PYY

Analysis of postprandial gut hormone concentrations in venous blood revealed that breads incorporating intact plant cells gave rise to elevated and sustained released of satiety-promoting hormones (FIG. 1-1J-R). Plasma GIP responses (FIG. 1-1J-L) were found to differ in the latter phase of the postprandial period (FIG. 1-1J) following the different bread roll types and remained elevated for longer (at 180 min and 240 min) following consumption of bread rolls containing 60% CCP (p=0.006 and p=0.004, respectively). This is reflected in the significantly higher GIP iAUC following the 60% CCP bread compared with the control (p=0.014, FIG. 1-1K). Peak plasma GIP concentrations were similar and occurred after ˜70 min, regardless of meal type.

Plasma GLP-1 responses (FIG. 1-1M). were overall significantly higher after consumption of 30% and 60% CCP bread compared to the control bread (meal×time interaction, p<0.001), and were particularly pronounced during the late postprandial period. While the peak plasma concentrations (Cmax) reached were similar for all bread types, the GLP-1 concentrations peaked >40 min later when participants consumed the 60% CCP bread than after the control and 30% CCP breads (Table S1). Overall, this prolonged plasma GLP-1 response to CCP-enriched bread is reflected in a doubling of the iAUC (FIG. 1-1N) for the GLP-1 response following consumption of 60% CCP compared to control (p<0.001). While the overall mean iAUC for GLP-1 following 30% CCP was not found to be significantly different from the control bread (p=0.096), it is noteworthy that the GLP-1 response appears to increase in a dose-dependent manner for most individuals (FIG. 1-1O). More broadly, the mean gut hormone data suggested a tendency for all mean iAUC gut hormone responses to increase in a dose-dependent manner, however, for all gut hormones analysed, the differences in iAUC only reached statistical significance at the 60% CCP inclusion. It may be that the use of iAUC to summarise XY data could be introducing some inaccuracies, but inter-individual differences may also play a role; notably, we identified ‘non-responders’ but have not excluded their data from the statistical analysis (see individualised data within FIG. 1-1L,O and R).

Similar to the GLP-1 responses, postprandial plasma PYY responses were also significantly increased overall (p<0.001) following consumption of the 30% and 60% CCP breads relative to the controls (FIG. 1-1PQR), with PYY concentrations reaching higher levels and remaining elevated for longer following the CCP-enriched breads. For the control bread, PYY concentrations peaked within the first 24 min of meal consumption, but when participants consumed CCP-enriched breads, the peak PYY concentrations were reached ˜40 to 76 min later (at approx. 1 to 2 h after meal consumption) and the magnitude of the peak PYY response (ΔPYY, change from fasted levels) was up to ˜170% higher than that elicited by the control bread (FIG. 1-1R and Table S1). Furthermore, after consuming the 60% CCP bread, PYY concentrations at 4 h (the last time point sampled) after the meal were still considerably higher than the max PYY response to the control bread.

Overall, our analysis of postprandial blood samples demonstrate that enrichment of white wheat bread with intact plant cells (CCP) significantly reduced the glycaemic and insulinaemic response to bread, while also significantly increasing and prolonging the postprandial release of anorexigenic gut hormones for at least 4 h after meal consumption.

TABLE 3
The peak value (Cₘₐₓ) and time to peak (Tₘₐₓ) for blood glucose,
plasma insulin, plasma C-peptide, plasma GIP, GLP-1 and plasma PYY
following consumption of 50 g of available carbohydrate consumed
as bread rolls containing 0 (control), 30% or 60% chickpea powder (CPP).
Data presented as geometric mean ± SD factor, significance (P < 0.05)
determined by repeat measures ANOVA; ^{a}Significantly different from
Control, ^{b}Significantly different from 30% CCP.

| | | | | P |
|---|---|---|---|---|
| | Control | 30% CCP | 60% CCP | value |
| Plasma | | | | |
| Glucose | | | | |
| Cₘₐₓ (mM) | 6.86 ± 1.19 | 6.19 ± 1.23^{a} | 5.86 ± 1.17^{a} | <0.001 |
| Tₘₐₓ (min) | 31.88 ± 1.31 | 25.24 ± 2.30 | 28.16 ± 2.917 | 0.301 |
| Plasma | | | | |
| Insulin | | | | |
| Cₘₐₓ (mU/L) | 72.50 ± 1.69 | 68.91 ± 1.68 | 51.96 ± 1.68^{a} | <0.025 |
| Tₘₐₓ (min) | 39.72 ± 1.53 | 32.83 ± 2.45 | 35.90 ± 1.57 | 0.661 |
| Plasma | | | | |
| C-Peptide | | | | |
| Cₘₐₓ (μg/L) | 4.74 ± 1.43 | 4.28 ± 1.38 | 3.47 ± 1.29^{ab} | <0.01 |
| Tₘₐₓ (min) | 49.47 ± 1.55 | 49.47 ± 1.46 | 42.97 ± 1.52 | 0.312 |
| Plasma GIP | | | | |
| Cₘₐₓ (ng/L) | 272.6 ± 1.44 | 293.1 ± 1.34 | 291.0 ± 1.42 | 0.568 |
| Tₘₐₓ (min) | 70.15 ± 1.46 | 69.56 ± 1.46 | 79.46 ± 1.65 | 0.237 |
| Plasma | | | | |
| GLP-1 | | | | |
| Cₘₐₓ (nM) | 46.51 ± 1.44 | 54.62 ± 1.50 | 54.76 ± 1.34 | 0.217 |
| Tₘₐₓ (min) | 37.37 ± 1.83 | 46.35 ± 1.69 | 87.25 ± 1.57^{ab} | <0.001 |
| Plasma PYY | | | | |
| Peak (ng/L) | 100.9 ± 1.45 | 117.4 ± 1.42 | 120.5 ± 1.33^{a} | <0.015 |
| Tₘₐₓ (min) | 24.13 ± 6.03 | 66.44 ± 2.93 | 100.3 ± 1.33^{a} | 0.004 |

### High Levels of Intact Cells are Needed to Influence Subjective Satiety

To explore if the different bread types and measured hormone responses would be associated with sensations of satiety and food intake, we asked study participants to record their sensations of fullness, hunger, discomfort etc. at regular time points for up to 4 h after eating each bread type. The combined satiety score was calculated from visual analogue scales for hunger, fullness, food volume and desire to eat. We also recorded the amount of food consumed by the participants during an ad libitum lunch meal provided at 4 h to explore if the bread type had any effect on subsequent food intake.

A significant increase in the combined satiety score (FIG. 1-2A) was observed after consumption of 60% CCP bread compared with control. This is reflected in the significantly higher combined satiety score iAUC, which was 66% higher after the 60% CCP versus the control (p=0.019, FIGS. 1-2B and C). The different components used for assessing appetite and satiety in this study (i.e., hunger, desire to eat and food volume) consistently demonstrated an increase in satiety following consumption of the bread meal containing 60% CCP as shown by the hunger score (FIG. 1-2D). The ad libitum meal provided to participants following the experimental period did not demonstrate a significant reduction in food intake (p=0.180); however, there was a trend to lower consumption following the 60% CCP meal (FIGS. 1-2E and F). No significant differences were seen between the control and 30% CCP breads, which suggests that supplementation with 30% CCP is insufficient to affect sensations of satiety. Although the total meal weight (bread roll and drink) was matched for all bread types, the visual analogue scale (VAS) responses to the question on meal volume shows that the participants did notice the larger bread roll size at the 60% dose, but this had no adverse impact on digestive comfort (FIG. 1-2G-I).

Overall, the replacement of 60% wheat flour with CCP resulted in a bread that elicited higher and sustained circulating levels of anorexigenic gut hormones (FIG. 1-1) and also increased participant reported sensations of satiety (FIG. 1-2).

### Differences in Nutrient Release During Digestion Underpin Effects on Postprandial Responses.

As gut hormone production can be stimulated by nutrient concentrations in the intestinal lumen, we also explored and compared the luminal release (bioaccessibility) of starch and protein digestive products from breads under simulated oral, gastric and small intestinal digestive conditions (INFOGEST 2.0 protocol). We found that the main release of amylolytic products of starch digestion (expressed as maltose equivalents) occurred rapidly during the early small intestinal phase, and tended to be higher in the control 0% CCP bread than the 30 and 60% CCP breads (FIG. 1-3A)—this is in good agreement with higher plasma glucose concentration observed for the control bread (FIG. 1-1A) and consistent with our previous observations of slow rates of starch release from intact plant cells (Bajka et al., 2021).

Data from in vitro digestion of bread indicate that the production of free amino acids from protein hydrolysis also occurred mainly in the early intestinal phase, and tended to increase with higher doses of CCP inclusion (FIG. 1-3B). This is likely due to the higher protein content of 25.5 mg protein/mg dry matter for the 60% CCP bread versus 17 mg protein/mg dry matter for the control, rather than the former's intrinsic protein digestibility. When this is taken into account, the free amino acids measured in simulated luminal fluid at the end of digestion account for ˜40% of the initial total protein mass, regardless of bread type, and could indicate that although breads were digested at different rates, a similar proportion of protein would eventually be available for absorption (FIG. 1-3B). The amount of maltose released from starch at the end of the small intestinal phase accounted for approximately 82% of the initial mass of starch within each bread type. Thus, it seems that a similar proportion of total starch would be eventually be digested regardless of bread type.

The higher amount of total free amino acids released from the CCP breads during in vitro digestion (FIG. 1-3B) is consistent with our analysis of postprandial serum amino acid responses in humans reposted in FIG. 1-3C and included as an exploratory outcome. Total serum amino acid concentrations were found to increase in a dose-dependent manner, and remained elevated for longer after the 30 and 60% CCP bread compared with the control bread. The total serum free amino acid concentrations peaked at ˜60 min, and the overall amino acid iAUC (FIG. 1-3D) was significantly higher when participants consumed the 60% CCP bread compared to the control bread (p=0.0003). The higher mean amino acid iAUC following 30% CCP.

### Discussion:

The increased prevalence of obesity worldwide is, in part, due to the accessibility of processed high glycaemic foods with only transient hunger suppression. A transformative dietary shift is needed, but it is challenging for people to change their diet when it is interlinked with cultural and societal behaviours. Therefore, improving the health profile of staple foods like white bread is a simple diet-based strategy that can improve metabolic response and potentially improve weight control. Flour is the main ingredient in bread and bakery, but due to the way it is milled, it lacks the beneficial intact plant cell structure found in whole grains. This study uses a novel cellular legume flour to demonstrate, for the first time, that inclusion of intact plant cells in white bread increases circulating levels of satiety-promoting hormones (GLP-1 and PYY) and fullness sensation, while also lowering blood glucose and insulin responses. These beneficial effects were clearly attributed to the slow digestion behaviour of the intact cells, which are not present in conventionally milled white or wholemeal cereal or legume flours.

Our studies provide evidence for a plausible mechanism by which intact legume plant cells influence appetite regulation (Pälchen et al., 2022) in the early postprandial state via the anorexigenic gut hormones, and does not seem to be dependent on the delivery of resistant starch to the distal gut (i.e., microbial fermentation). The observed stimulatory effects of CCP-enrichment on circulating anorexigenic gut hormones is likely explained by the differential spatio-temporal release of cell encapsulated nutrients from these meals during digestive transit. Indeed, given the increased satiety following consumption CCP-enriched breads, the elevated circulating anorexigenic gut hormones may suppress feelings of hunger following dips in plasma glucose reported previously (Wyatt et al., 2021).

The slower release of starch from chickpea cells (as seen here in vitro) would result in higher luminal concentrations of mono- and disaccharides towards the distal gut and stimulate local enteroendocrine cells with GLP-1 and PYY-producing capacity (Beumer et al., 2020; Aygul Dagbasi et al., 2020; Steinert et al., 2017). The highest density of these enteroendocrine cells is in the colon, and others have suggested that the colonic microbial fermentation of resistant starch (RS) into short chain fatty acids within this region may stimulate gut hormone production (Canfora et al., 2017; Chambers et al., 2015), although evidence for this mechanism in humans remains equivocal. However, considering that the mean transit time to the ileo-caecal junction in humans is 3-6 h (Maljaars et al., 2008), we believe the acute differences in gut hormone responses observed within the present 4 h postprandial study are driven mainly by non-microbiome mediated digestion in the small intestine. Thus, our study points to a different mechanism to previous studies in which fermentation of RS into short chain fatty acids has been suggested to stimulate satiety. Our observations are better described by the ileal brake mechanism—a combination of processes mediated by GLP-1 and PYY in which macronutrients downregulate digestion and suppress food intake (Maljaars et al., 2008).

While encapsulated starch has been the main focus of our previous studies, the novel chickpea cell flours studied here also contain ˜20% protein, and the digestion behaviour of protein within the chickpea cells is less well understood. Recent evidence suggests that the cell-wall barrier mechanism applies also to protein (Pälchen et al., 2021); however, our analysis suggest that some (but not all) of the encapsulated chickpea protein within these breads was in fact bioaccessible and bioavailable. Thus, the postprandial satiety-promoting effects observed in response to intact plant cells (type 1 RS) may not be due to the delayed starch digestion alone, but could also be attributed to the release and digestion of peptides from co-located encapsulated protein. In fact, while evidence for RS effects on acute satiety in humans is limited and mechanisms unconfirmed (Cai et al., 2021), there is strong evidence for acute effects of protein in satiety regulation (Santos-Hernández et al., 2018).

The observed effects on postprandial glucose, insulin and GIP responses are explained by the early luminal appearance of macronutrient digestion products within the upper-small intestine. Blood glucose responses are strongly influenced by availability of luminal glucose from starch digestion (Edwards et al., 2019; Ellis et al., 1995), so the limited bioaccessibility and digestion of intracellular starch provides an explanation for the attenuated postprandial glycaemic responses to the test breads. Insulin (and C-peptide) responses tend to reflect the changes to plasma glucose levels, and thus were reduced or unchanged in response to intact plant cell intake. This is consistent with the participants being healthy with adequate blood glucose control. Similar mechanisms are likely to underpin the observed GIP responses; rising luminal glucose concentrations in the duodenum are known to be detected by K-cells with GIP production capacity. Glucose derived from the rapidly digested wheat starch (present in all meals) is likely to have stimulated the initial GIP response, but the prolonged GIP response seen from 90 min onwards following intact plant cell consumption from CCP bread could reflect continued stimulation due to slower availability of hydrolysed products of starch and/or proteolytic products from intact plant cells (Santos-Hernández et al., 2018). An additional consideration is that gastric emptying of meal components will also have affected duodenal nutrient concentrations. Although attempts were made to match total meal volume, the differential release of meal components may have occurred, due to gastric sieving and faster gastric transit of liquid with aqueous components (Kong & Singh, 2009; Wang et al., 2021). For instance, intact plant cells may have been retained in the stomach for longer than the surrounding bread matrix. Gastric emptying is also known to be down-regulated by GLP-1 and PYY via ileal brake processes (Maljaars et al., 2008), which may play a role in the late postprandial responses. The implications of this mechanism in the maintenance of the satiety response merits further investigation.

A limitation of our study is that, due to the complex nature of RS1, the meals inevitably varied not only in encapsulated starch but also in encapsulated protein content. Our original hypothesis was focused on the impact of the cell wall barrier mechanism on starch digestion, but our results provide evidence of slow release and digestion of both starch and protein digestion products. Nevertheless, our observations of gut hormone response to plant cells in bread complement the findings of a recent study where nutrient-matched chickpea purees differing only in plant cell intactness were found to have different effects on subjective appetite (Pälchen et al., 2022). There have been relatively few studies of the effect of plant cell encapsulation on protein release, and further studies should include comparisons of gut hormone responses to protein-matched meals.

With regard to future applications, the beneficial effects of cellular flours on postprandial metabolic responses and subjective satiety scores are highly encouraging, and warrant further investigation in a non-clinical setting.

Overall, this study adds to a growing body of evidence (Capuano & Pellegrini, 2019; Ellis et al., 2004; M. M. L. Grundy et al., 2016; Parada & Aguilera, 2011) that dietary fibre structure in the form of intact plant cell walls plays a critically important role in altering macronutrient bioavailability and postprandial metabolism. Our new findings that plant cell structure also influences the anorexigenic response to food is highly relevant to understanding the relationship between dietary fibre intake, obesity and cardiometabolic risk as reported in epidemiological studies (Kim et al., 2016). An important implication of our study is that dietary fibre supplementation with disrupted cells may not be as effective in supporting cardiometabolic health as the consumption of whole foods, where the plant cell structures are intact. This is an important consideration in designing effective strategies for dietary fibre supplementation.

In conclusion, the present study demonstrates how incorporation of novel cellular flour into a processed food product has beneficial effects on glycaemia, insulinaemia and release of satiety-promoting gut hormones. Overall, the intact legume cell powders reveal a slow digestion behaviour and their incorporation into bread or other food products provides a new dietary strategy of stimulating release of satiety-promoting gut hormones. As the mechanisms is dependent on the slow-release properties of intact plant cells, conventionally-milled flours including pulse flours or wholemeal flours are unlikely to have similar effects. Considering the magnitude of the observed effects seen acutely in healthy individuals after a palatable meal, we believe further chronic studies to investigate the therapeutic potential of cell powders in body weight and diabetes management are justified.

Furthermore, a nutritionally significant proportion of encapsulated legume protein within CPP was bioaccessible during duodenal digestion. Consequently, the replacement of refined wheat flour with intact chickpea cells improved both the amount and diversity of bioavailable EAAs. EAAs released as small peptides and free amino acids during INFOGEST simulated in vitro digestion were strongly correlated to the EAA profile of human serum following consumption of the bread products studied. Overall, enrichment of white wheat bread with novel cellular legume flour provides opportunities to improve both protein and carbohydrate quality for potential benefits to cardiometabolic and gut health.

### Materials & Methods 1

### Bread Products for In Vitro and In Vivo Testing

Wheat bread rolls were prepared in which 30 or 60% of the refined white wheat flour was replaced in the breadmaking recipe with a novel cellular chickpea flour (CCP, WO 2019/155190 A1, available commercially as PulseON®, Pulseon Foods Ltd., Chesterfield, UK). Further details on the methods used to prepare the powder (PulseON®) and its techno-functional characteristics have been published previously (Bajka et al., 2021; Edwards, Ryden, Pinto, van der Schoot, Stocchi, Perez-Moral, Butterworth, Bajka, Berry, Hill, et al., 2020). A control wheat bread (0% CCP) made with 100% white flour was also prepared.

The formulation and bread preparation method has been described in full previously (Bajka et al., 2021). In brief, the CCP bread rolls include in a % wet basis (ingredient mass/dough mass): 44.1 to 50.3% water, 12.8 to 33.4% white wheat bread flour (Taste the Difference Very Strong Canadian Bread Flour, Sainsbury's, London, UK); 1.0% sucrose (white caster sugar, Sainsbury's, London, UK); 0.8% NaCl (Saxa table salt, Premier Foods, St Albans, UK); 1.8% vegetable fat (Trex Vegetable Baking Fat, Princes Group, Liverpool, UK); 2.4 to 5.2% wheat gluten (Vital Wheat Gluten 75-80% protein, Bob's Red Mill, Milwaukie, US), 0.1% ascorbic acid (Dove's farm, Hungerford, UK), purchased from Amazon; and 0.9% dry Baker's yeast (Ferminpan Red, Lallemand, Felixstowe, UK) provided by Lallemand. The entire dough was divided into matched bread rolls so that each bread roll provided a similar amount of starch per serving (measured macronutrient composition of these breads is provided in Table 1). Full details of the preparation and characteristics of these bread rolls has been reported previously (Bajka et al., 2021).

TABLE 1
Macronutrient composition* of bread
rolls (per 100 g as served basis).

| | 0% | 30% | 60% |
|---|---|---|---|
| | CCP | CCP | CCP |
| Moisture (g/100 g) | 34.0 | 41.5 | 47.0 |
| Energy (kJ/100 g) | 1132.0 | 1001.0 | 906.1 |
| Protein (g/100 g) | 11.2 | 11.8 | 13.5 |
| Fat (g/100 g) | 2.9 | 3.7 | 4.4 |
| Starch (g/100 g) | 39.4 | 29.9 | 21.1 |
| Sugars (g/100 g) | 2.4 | 2.3 | 2.8 |
| Dietary Fibre | 2.3 | 4.1 | 5.3 |
| (g/100 g) | | | |
| Serving size | 115.0 ± 2.7 | 150.0 ± 1.6 | 201.2 ± 1.3 |
| (g per roll) | | | |

*Proximate analyses of the macronutrients are described in detail in a recent publication (Bajka et al., 2021).

### Acute Postprandial Study

### Study Participants

Healthy participants aged 18-45 years were recruited using advertisements around King's College London,

including circular e-mails and posters. Exclusion criteria included: body mass index (BMI)<18 or >35 kg/m², blood pressure ≥160/100 mm Hg, fasted glucose >6.0 mmol/L, plasma cholesterol ≥7.8 mmol/L, plasma triacylglycerol ≥5.0 mmol/L, medications that may interfere with the study (e.g. antidiabetic or lipid-lowering drugs), allergy or sensitivity to wheat, alcohol intake >28 units/week and active or recent cessation of smoking (<6 months). Participants were healthy with no history of cardiovascular disease, diabetes or gastrointestinal disorders, as confirmed by a full medical history (Table 2). BMI, blood pressure, liver function, blood cell count, fasting plasma glucose and lipid concentrations were confirmed to be within limits during a screening clinical visit that took place before confirming enrolment. Individuals who met all inclusion and exclusion criteria were randomly allocated their treatment order using Sealed Envelope™ (www.sealedenvelope.com, Sealed Envelope Ltd., London, UK). The allocation of treatment sequence was blinded from the investigators, technicians performing analysis of blood samples and participants.

Investigators and participants remained blinded until completion of the study and data analysis. The study was conducted in accordance with the Declaration of Helsinki and approved by the relevant research ethics committee (HR-18/19-8431, BDM Research Ethics Subcommittee at King's College London) in the UK and registered at clinicaltrials.gov as NCT03994276. All participants gave their written informed consent after being provided with oral and written information about the aims and protocol of the study. Data were stored in accordance with the General Data Protection Regulation 2018 and biological samples were handled, stored, transported and disposed of in accordance with the Human Tissue Act (2004). Participants were reimbursed for their time and travel expenses upon completion of the study.

TABLE 2
Physical characteristics of enrolled study participants (mean ± SD).

| | Total study |
|---|---|
| | participants |
| | (n = 20) |
| Male/Female (n) | 10/10 |
| Age (years) | 27.90 ± 4.91 |
| BMI (kg/m²) | 24.68 ± 3.09 |
| Fasted plasma glucose | 4.80 ± 0.41 |
| (mM) | |
| Fasted total cholesterol | 4.40 ± 1.12 |
| (mM) | |

### Study Design

A randomised, controlled, double-blind, cross-over design study was undertaken at the Metabolic Research Unit (MRU), Department of Nutritional Sciences, King's College London, between August 2019 and January 2020. The trial investigated the effects of chickpea PulseON® (consisting predominantly of intact cells) on 4 h postprandial gut hormones (GLP-1, PYY and GIP), appetite, glucose, insulin and C-peptide responses. Three bread rolls incorporating different quantities of PulseON® (0, 30 or 60%, w/w, of refined wheat flour replaced with PulseON®) were consumed by participants in random order, at 3 separate study visits and with at least 4 days wash-out between each visit. Replacement of wheat flour with PulseON® meant that ˜12 and 30 g of the total starch in the 0% bread roll was replaced by starch from PulseON® to make the 30% and 60% bread rolls, respectively. Each bread roll was served with 20 g of no-added sugar strawberry jam (energy reduced strawberry jam with sweetener, Marillo Foods Ltd., West Yorkshire, UK) providing <0.4 g sugars (mainly fructose) and 12.8 g polyols (mainly from sorbitol), to aid palatability. The total weight of drinking water served with each meal was adjusted in order to achieve a constant total weight of 420 g, since the different type of breads had different weights, due mostly to the differences in moisture content. Participants were instructed to consume the meal at their normal pace which was standardised based on their first visit. Each participant received a different bread roll treatment on each of three separate visits to the MRU.

On the morning of each intervention, the participants arrived at the MRU after a 12 h fast and having consumed a standard evening meal (350-450 kcal and <12 g fat per serving, and <3 g dietary fibre per 100 g) the previous evening. A venous cannula was inserted in a vein in the antecubital fossa or a forearm vein by a trained phlebotomist. Baseline fasted blood samples (˜t−15 min) were collected before the allocated test meal was consumed at t0 min, and blood samples were subsequently taken at frequent intervals up to 4 h post-test meal (t=15, 30, 45, 60, 90, 120, 180 and 240 min). Blood samples were collected into BD Vacutainer® tubes: fluoride/oxalate tubes for glucose analysis; SST™ serum tubes for insulin and C-peptide analysis, and into K2 EDTA tubes with DPP-IV (10 μL/mL blood, Merck Millipore) and aprotinin (500 KIU/mL blood, Nordic Pharma) for GIP, GLP-1 and PYY analysis. All samples were centrifuged at 1300 g, 4° C. for 15 min and plasma/serum aliquots were stored at −80° C. until used for biochemical analyses, performed by a clinical pathology accredited biochemistry laboratory (Affinity Biomarkers Labs, London). Glucose was determined enzymatically on a Siemens Advia 1800 auto-analyser, and insulin and C-peptide by Seimens Centaur XP (Siemens Healthcare Diagnostics Ltd., Frimley, Surrey, UK). Plasma gut hormone concentrations (GIP, GLP-1 and PYY) were determined by electro-chemiluminescent multiplexed assay (Mesoscale Discovery, MD, USA). Amino acids were determined using UPLC-MS/MS method, described in the section below. Out of the 21 participants recruited, 20 completed the study (FIG. 1-S1); however, one of the volunteers was unable to provide venous blood samples following consumption of one of the test meals (n=20 for control 0% and 30% CCP, n=19 for 60% CCP).

Visual Analogue Scales (VAS) were completed at baseline (t−10 min), after the test meal (t10 min) and at 30, 60, 90, 120, 180 and 240 min. Participants marked responses to satiety questions (“How hungry do you feel?”, “How full do you feel?”, “How strong is you desire to eat?”) using 100 mm Visual Analogue Scales (VAS), with questions that were anchored from “Not at all” to “Extremely”. Additionally, participants were asked “How would your rate your digestive comfort”, anchored from “Very uncomfortable” to “Very comfortable”, and “How much do you think you can eat”, anchored to “Nothing at all” and “A lot”. The combined satiety score (FIG. 3A) was calculated as: ((100−Hunger)+(100−Desire to eat)+(100−Food Volume)+(1/Fullness))/4 (Gibbons et al., 2019). Following the completion of the test period, at t255 min, participants were provided with an ad libitum lunch, consisting of pasta, tomato-based sauce and cheese. Ad libitum energy intake was calculated from the total amount of food consumed (in grams) at the end of each test period.

### Analysis of Amino Acids in Plasma Samples

Plasma extraction for amino acids analysis was adopted from a previously published method (Kok et al., 2019). Briefly, isotope labelled internal standards (canonical amino acid mix, Cambridge Isotope Laboratories, Inc., Massachusetts, USA) dissolved in 90 μL of 60% acetonitrile were added to 10 μL plasma sample/calibration standards, vortexed for 1 min and kept at 4° C. for 5 min. Samples were then centrifuged at 13000 g (4° C.) for 10 min. The supernatant was transferred into HPLC vials for LC-MS/MS analysis. The UPLC-MS/MS method was optimised for targeted amino acids analysis in the samples using a HILIC column in an Agilent 1290 LC system coupled to a 6490 mass spectrometer with a jet stream electrospray ionization source. Separation of amino acids was carried out according to the chromatographic method described by Prinsen and colleagues (Prinsen et al., 2016). Amino acids were detected in a 1 μL extracted plasma sample injection by multiple reaction monitoring (MRM) mode using positive electrospray polarity. Quantification was performed using the concentration vs peak area ratio (the integrated peak area of the analyte to that of the internal standard) calibration curve and data were processed with MassHunter Workstation Quantitative Analysis software (version 10.0, Agilent Technologies). The total amount of free amino acids was calculated by adding all the individual amino acids measured in each sample.

### In Vitro Digestion of Bread Rolls

The digestibility of 0, 30 and 60% CCP breads was determined in vitro in accordance with the international consensus method published by Brodkorb and co-workers (Brodkorb, Egger, Alminger, Alvito, Assunção, Ballance, Bohn, Bourlieu-Lacanal, Boutrou, Carrière, et al., 2019), following the individual enzyme format. Digestions were performed in triplicate for the breads containing 30 and 60% of chickpea powder and in duplicate for the control 0% bread for each time point at 37° C. In each digestion tube, 0.228 g of bread crumbs (1-2 mm) and 0.572 mL water were mixed with 0.8 mL simulated oral (pH 7), 1.6 mL gastric (pH 3) and 3.2 mL intestinal (pH 7) fluids to mimic the conditions of electrolytes, pH, bile salts and enzymes in the mouth, stomach and small intestine. Individual enzymes for the oral phase (salivary α-amylase), gastric phase (pepsin) and intestinal phase (pancreatic α-amylase, trypsin, chymotrypsin,) at the specified activities (based on enzyme activity assays as per (Brodkorb, Egger, Alminger, Alvito, Assunção, Ballance, Bohn, Bourlieu-Lacanal, Boutrou, Carrière, et al., 2019) were added to each time point as per the standard protocol. Bile salts were added to the intestinal phase. A blank digestion containing all the enzymes and fluids with water instead of bread was included for each time point in each bread to account for the background values of the fluids, enzymes and bile salts employed. The digestion was stopped (by addition of an equal volume of 0.3 M sodium carbonate solution and, for the intestinal samples only, 50 μL of pefabloc 0.1 M per mL of intestinal digesta) at the end of the oral phase, after 30 and 60 min of gastric digestion and at 0, 5, 10, 20, 30, 60 and 120 min of small intestinal digestion, sacrificing one tube for each time point.

Inactivated samples of digesta were frozen immediately and stored at −80° C. for subsequent analysis. All reagents were from Sigma-Aldrich Co. Ltd (Poole, Dorset, UK).

Analysis of Maltose and Amino Acids Produced from In Vitro Digestion

Inactivated digesta from different time points were thawed and centrifuged at 3000×g for 10 min at 4° C. The concentration of free amino acids and reducing sugars (mainly maltose) in the supernatant was measured in aliquots taken from the supernatant. Maltose concentrations were determined using the ‘pahbah’ (p-hydroxybenzoic acid hydrazide) reagent method (Edwards et al., 2019; Lever, 1972). Free amino acids in the supernatant were measured by LC-MS/MS (Agilent 6490 mass spectrometry), following the same method as used for human plasma samples, described above. Concentrations present in the digesta from the blank runs were subtracted from concentrations present in the corresponding digesta from the bread runs.

The resulting net concentration of maltose or free amino acids in the digesta was divided by the initial food sample (dry matter basis) and plotted over time to represent release of these starch and protein digestion products from each bread type.

### Microscopy

Light micrographs were captured with an Olympus BX60 Microscope equipped with Jenoptik ProgRes camera and a ProgRes CapturePro software. Inactivated samples of in vitro digesta from the end of oral, gastric and duodenal digestion were thawed and stained with Lugol's Iodine (I2/KI) and/or 1% Tolouidine blue solution (Sigma Aldrich Ltd., UK) prior to viewing.

### Data and Statistical Analysis

Statistical analyses of in vitro digestion, visual analogue scale and blood biochemistry data (including iAUC, Cmax and Tmax) and graphical representations were done using GraphPad Prism 9.3.1 software (GraphPad Software LLC, San Diego, USA). iAUC values are the ‘first peak’ areas and were calculated in GraphPad Prism 9.3.1 for individualised data using the area below the first-peak and above the fasted baseline. In vitro data was analysed by repeated measures ANOVA, and in vivo data analysed by mixed model ANOVA, with time and treatment (e.g., bread roll type) as fixed effects and individual differences as random effects. All data are presented as means±SEM unless otherwise specified, and the number of participants (n) whose data was included in each analysis is indicated in FIG. 1-legends and throughout the text. Outliers were not excluded.

Post hoc analyses were performed when significant treatment×time effects were detected, and Tukey's correction for multiple comparisons applied (multiplicity adjusted p-values reported). Statistically significant effects were accepted at the 95% confidence level.

### Supplementary Data:

S1=consort
S2=bread info
S3=micrographs
S4=correlation plots

TABLE S1
Peak parameters of the glycaemic, insulinaemic
and gut hormone responses to bread types

[symbol]

| | Control | 30% CCP | 60% CCP | p-value |
|---|---|---|---|---|
| Plasma | | | | |
| Glucose | | | | |
| Fasting (mM) | 4.81 ± 1.04 | 4.84 ± 1.11 | 4.79 ± 1.09 | 0.797 |
| Cₘₐₓ (mM) | 6.86 ± 1.19 | 6.19 ± 1.23 [symbol] | 5.86 ± 1.17 [symbol] | <0.001 |
| Tₘₐₓ (min) | 31.88 ± 1.31 | 25.24 ± 2.30 | 28.16 ± 2.917 | 0.301 |
| Plasma | | | | |
| Insulin | | | | |
| Fasting (mU/L) | 9.93 ± 2.23 | 10.08 ± 2.03 | 10.75 ± 2.37 | 0.632 |
| Cₘₐₓ (mU/L) | 72.50 ± 1.69 | 68.91 ± 1.68 | 51.96 ± 1.68 [symbol] | <0.025 |
| Tₘₐₓ (min) | 39.72 ± 1.53 | 32.83 ± 2.45 | 35.90 ± 1.57 | 0. [symbol] 61 |
| Plasma | | | | |
| C-peptide | | | | |
| Fasting (μg/L) | 1.17 ± 1.65 | 1.16 ± 1.57 | 1.14 ± 1.59 | 0.950 |
| Cₘₐₓ (μg/L) | 4.74 ± 1.43 | 4.28 ± 1.38 | 3.47 ± 1.29 [symbol] | <0.01 |
| Tₘₐₓ (min) | 49.47 ± 1.55 | 49.47 ± 1.46 | 42.97 ± 1.52 | 0.312 |
| Plasma GIP | | | | |
| Fasting (ng/L) | 48.59 ± 1.54 | 47.72 ± 1.66 | 52.58 ± 1.46 | 0.821 |
| Cₘₐₓ (ng/L) | 272.6 ± 1.44 | 293.1 ± 1.34 | 291.0 ± 1.42 | 0.568 |
| Tₘₐₓ (min) | 70.15 ± 1.46 | 69.56 ± 1.46 | 79.45 ± 1.65 | 0.237 |
| Plasma | | | | |
| GLP-1 | | | | |
| Fasting (nM) | 18.26 ± 1.54 | 19.48 ± 1.47 | 18.12 ± 1.52 | 0.851 |
| Cₘₐₓ (nM) | 46.51 ± 1.44 | 54.62 ± 1.50 | 54.76 ± 1.34 | 0.217 |
| Tₘₐₓ (min) | 37.37 ± 1.83 | 46.36 ± 1.69 | 87.25 ± 1.57 [symbol] | <0.001 |
| Plasma PYY | | | | |
| Fasting (ng/L) | 79.79 ± 1.51 | 81.06 ± 1.34 | 75.47 ± 1.42 | 0.725 |
| Cₘₐₓ (ng/L) | 100.9 ± 1.45 | 117.4 ± 1.42 | 120.5 ± 1.33 [symbol] | <0.015 |
| Tₘₐₓ (min) | 24.13 ± 6.03 | 66.44 ± 2.93 | 100.3 ± 1.33 [symbol] | 0.004 |

[symbol]

The fasted, peak (Cₘₐₓ) and time to peak (Tₘₐₓ) values for blood glucose, plasma insulin, plasma C-peptide, plasma GIP, GLP-1 and plasma PYY following consumption of 50 g of available carbohydrate consumed as bread rolls containing 0 (control), 30% or 60% chickpea powder (CPP) [symbol] Data presented as geometric means ± SD factor, significance (p < 0.05) determined by repeated measures ANOVA; [symbol]
Significantly different from Control, [symbol]
Significantly different from 30% CCP. [symbol]
indicates data missing or illegible when filed

### Materials and Methods 2

### Bread Rolls

Three different bread types, denoted B0, B30 and B60, were prepared by replacing 0, 30 or 60% of white wheat bread flour with a novel cellular chickpea flour ‘CCP’ (tradename PulseON®, Pulseon Foods Ltd., Chesterfield, UK) (Edwards, Ryden, Pinto, van der Schoot, Stocchi, Perez-Moral, Butterworth, Bajka, Berry, Hill, et al., 2020). Full details of bread preparation, macronutrient composition and palatability have been described in full elsewhere (Bajka et al., 2021), but the present study is the first to report details of their protein digestibility and EAA bioaccessibility and bioavailability.

### In Vitro Digestion

Each bread type was subjected to simulated in vitro digestion following the INFOGEST 2.0 method (Brodkorb, Egger, Alminger, Alvito, Assunção, Ballance, Bohn, Bourlieu-Lacanal, Boutrou, Carrière, et al., 2019). In each digestion, 0.228 g of bread dry matter (crumbs, 1-2 mm size, obtained using a blender) and 0.572 ml water were mixed with simulated fluids that mimic the conditions of electrolytes, pH, bile salts and enzymes in the oral, gastric and duodenal phase. Individual enzymes i.e. salivary amylase, pepsin, trypsin, chymotrypsin, pancreatic amylase and bile salts at the specified activities or concentration were added to an individual tube for each time point. Digestions were performed in triplicate for B30 and B60 and in in duplicate for B0. A blank digestion containing all the enzymes and fluids with water instead of breadcrumbs was included in each run to account for the background values of the fluids, enzymes and bile salts employed. Digestions were performed to obtain a sample of the digesta at the end of the oral phase, after 30 min and 60 min of gastric phase and at 0, 5, 10, 20, 30, 60 and 120 minutes of intestinal digestion. At each time point, the digestion was stopped by addition of 0.3 M sodium carbonate (to inhibit amylases and pepsin) and pefabloc (inhibits proteases trypsin and chymotrypsin). The samples were frozen at −70° C. immediately afterwards.

### Fractionation of In Vitro Digesta

Samples of digesta collected at each time point were treated as per FIG. 2-1 to fractionate the solubilised components present in digesta supernatant into free amino acids (FAA), small peptides (SP), large polypeptides and solubilised proteins (LPP), using a modified adaptation of previously published methods (Pälchen et al., 2021; Roux et al., 2020). Basically, the in vitro digesta samples obtained at each time point were centrifuged at 3000×g for 10 min at 4° C. to exclude undigested food and big particulates from the supernatant. The resulting supernatant was then split into 3 aliquots which were differential processed (FIG. 2-1) and analysed for amino acids (AAs) content. The AAs present as Free Amino Acids' (FAA), ‘Small Peptides’ (SP), or ‘Large polypeptides and proteins’ (LPP) were then calculated from each fraction by applying the following equations (Equation 1ABC):

$$FAA = {FAA}_{fraction 1} \qquad ( Equation 1 A )$$

$$SP = {( FAA + SP )}_{fraction 2} - {FAA}_{fraction 1} \qquad ( Equation 1 B )$$

$$LPP = {( FAA + SP + LPP )}_{fraction 3} - {( FAA + SP )}_{fraction 1} \qquad ( Equation 1 C )$$

Equation 1—Calculation of amino acids present as Free Amino Acids (FAA), Small Peptides (SP) and Large proteins and polypeptides (LPP) using the amino acid content of protein fractions referred to in FIG. 2-1

For determination of AAs present as FAA (‘fraction 1’ in FIG. 2-1), the aliquoted supernatants were analysed directly by LC-MS/MS (see Section ‘amino acid extraction and quantification’ below). For determination of AAs present within containing FAA and SP (fraction 2′ in FIG. 2-1), the aliquoted supernatant was diluted 1:1 with TCA 6.4% before mixing and centrifuging at 5000 g for 30 min to exclude precipitated peptides and proteins and splitting the supernatant into three×1 mL aliquots, each subjected to different hydrolysis conditions (a, b or c, described below) as recommended by the official AOAC method for amino acid analysis 982.30 E(a,b,c)), the highest value obtained by any of these hydrolysis was taken: a) acid hydrolysis by incubation with 1 mL of 6M HCl at 110° C. for 24 hours to analyse most amino acids; b) basic hydrolysis by incubation with 1 mL saturated 0.4M Ba(OH)₂ at 110° C. for 24 h (this method is used to analyse tryptophan) and c) pre-oxidation by incubation with 1 mL of freshly prepared performic acid (9:1 formic acid: 30% hydrogen peroxide) left to oxidize for 20 h at 4° C. before adding 0.17 g sodium metabisulfite to decompose the performic acid, and then followed by an acid hydrolysis in 2 mL of 6M HCl at 110° C. for 24 h (this method was used to analyse sulphur-containing amino acids methionine and cysteine). For determination of AAs contained in FAA, SP and LPP (‘fraction 3’ in FIG. 2-1) the supernatant was hydrolysed following the acid and basic conditions described above. After the hydrolyses described in aliquots 2 and 3, the solvent in each sample was evaporated from the samples using a centrifugal rotaevaporator (Genevac EZ-2 Elite Personal Evaporator) and the solid resuspended in 1 ml of DDI water before being filtered and analysed by LC-MS. Total Nitrogen was also measured by combustion using an Exeter CE440 CHN Elemental Analyser and multiplied by the protein conversion factor 6.25 to estimate the amount of protein in undigested samples before and after gastro-intestinal digestion.

### Amino Acid Extraction and Quantification

Extraction for amino acids analysis in plasma and digesta samples was adopted from Kok et al. (Kok et al., 2019). Briefly, isotope labelled internal standards (canonical amino acid mix, Cambridge Isotope Laboratories, Inc. Massachusetts, USA) dissolved in 90 μl of 60% acetonitrile were added to 10 μl plasma sample/calibration standards, vortexed and kept at 4° C. for 5 min. Samples were then centrifuged at 13000×g at 4° C. for 10 mins. Targeted amino acids in the supernatant were analysed using a HILIC column in an Agilent® 1260 Infinity LC system coupled to a 6490 triple quadrupole mass spectrometer with an Agilent® Jet Stream source (Santa Clara, USA).

The amino acid separation was carried out according to the chromatographic method described by

Prinsen and colleagues (Prinsen et al., 2016) using a programmed gradient mobile phase after injecting 1 μl of extracted sample. The amino acids were detected by multiple reaction monitoring (MRM) mode using positive electrospray ionization. The source conditions were as follows: dry gas temperature 200° C.; dry gas flow 16 L/min; nebulizer pressure 50 psi; capillary voltage 3500 V; sheath gas temperature 300° C.; sheath gas flow 11 L/min; nozzle voltage 1000 V; high pressure RF 150 V; and low pressure RF 60 V. Collision energies (CE) were optimized for the amino acids transitions of interest. All transitions were used as qualifiers by automatic detection on specific retention time windows. One transition was used as quantifier.

Quantification was performed using the concentration vs peak area ratio (the integrated peak area of the analyte to that of the internal standard); calibration curve and data were processed with MassHunter Workstation Quantitative Analysis software (version 10.0, Agilent Technologies). These analyses was performed for measurement of the 9 essential amino acids (EAAs); Histidine (His), Iso-leucine (Ile), Leucine (Leu), Lysine (Lys), Methionine (Met), Phenylalanine (Phe), Threonine (Thr), Tryptophan (Trp) and Valine (Val), and for the following non-essential amino acids; Alanine (Ala), Arginine (Arg), Asparagine (Asn), Aspartic acid (Asp), Betain (‘Bet’), Cystine (Cys), Glutamic acid (Glu), Glutamine (Gln), Glycine (Gly), Hydroxy-Proline (Hyp), L-Ornithine (‘Lor’), Proline (Pro), Serine (Ser), Tyrosine (Try). Throughout this manuscript, the term ‘total amino acids’ (‘total AAs’) refers to the sum of the EEAS and the aforementioned non-EEAs, which were selected based on their nutritional relevance.

### Estimations of Amino Acid Bioaccessibility

Bioaccessible EAAs are defined here as the proportion of EAAs that had been released from the food matrix and are in a form that is potentially available for absorption. Non-food sources of EAAs were subtracted from the total by using values obtained during ‘blank’ digestion runs. We consider that food-derived EAAs within the FAA fraction would likely be bioaccessible, but those within the SP fraction could also be considered bioaccessible, particularly if digested by brush border peptidases that are present in vivo, but were not included in the in vitro digestion model. To explore this further, we calculated EAA bioaccessibility in two ways using the measured EAAs within the FAA fractions without (Equation 2A) or with inclusion of small peptides (Equation 2B) fractions of digesta. The same equation and principles were also applied to calculate bioaccessibility of individual amino acids (i.e. using only the values for the EAA of interest rather than the sum of all EAAs). The basis for bioaccessibility calculations is defined in the Figure legends.

$$BioAc total EAA ( \% ) = \frac{{EAA}_{FAAt}}{\sum {EAA}_{t}} \times 100 \qquad ( Equation 2 A )$$

$$BioAc total EAA ( \% ) = \frac{{EAA}_{FAAt} + {EAA}_{SPt}}{\sum {EAA}_{t}} \times 100 \qquad ( Equation 2 B )$$

Equation 2—Total EAA bioaccessibility is calculated as the sum of measured amounts of food-derived EAAs (μg released per mg bread dry matter) in either the FAA fractions (EAA_{FAAt}) as in eqn. 1A, or within the SP+FAA fractions, eqn. 1B, after 120 min of duodenal digestion, divided by the total amount of EAA present in the original bread product (μg/mg bread dry matter).

### Imaging

Images of breads were produced using a Zeiss LSM880 confocal laser scanning microscope and processed using ZEN Blue software. Samples of digested breads resuspended in water were mixed with calcofluor-white and fast green FCF (Sigma-Aldrich Co, Poole, UK) to stain cell walls and protein respectively for 10 min before centrifuging for 5 min at 5000 g. The pellet was resuspended and rinsed 3 times with water before placing an aliquot on a glass slide. The samples were imaged using laser excitations of 405 nm and 561 nm and emissions of 452 nm and 640 nm for calcofluor and fast green, respectively.

### Human Postprandial Blood Sample Collection

This investigation used blood samples collected from healthy human participants (n=20) following consumption of B0, B30 and B60 bread types as part of a previous study. This previous human study was conducted in accordance with the Declaration of Helsinki and approved by the relevant research ethics committee (HR-18/19-8431, BDM Research Ethics Subcommittee at King's College London) in the UK. All participants gave their written informed consent. The study was registered at clinicaltrials.gov as NCT03994276, and full details of the study protocol have been published elsewhere (Bajka et al., 2021).

In brief, the study followed a double-blind, randomised, controlled, cross-over design, in which each participant consumed each bread type on separate study visits in random order. Each bread was served as a bread roll together with 20 g of no-added sugar strawberry jam (energy reduced strawberry jam with sweetener, Marillo Foods Ltd., West Yorkshire, UK) and a drinking glass with water. For each visit, participants arrived having fasted for 12 h to the Metabolic Research Unit, Department of Nutritional Sciences, King's College London, where the study was taking place between August 2019 and January 2020. Upon arrival, a trained phlebotomist inserted a venous cannula in a vein in the antecubital fossa or a forearm vein for subsequent venous blood sampling. Blood samples used for amino acid analysis were collected into BD Vacutainer® SST serum tubes before test meal consumption (−15 min) and at 15, 30, 45, 60, 90, 120, 180 and 240 min postprandially. All samples were centrifuged at 1300×G, 4° C. for 15 min and aliquots of the supernatant stored at −80° C. prior to amino acid analysis (see ‘Amino acid quantification’)

### Data and Statistical Analysis

Graphical and statistical analysis were performed using GraphPad Prism 9.0 for Windows (Version 9.3.1, GraphPad Software, LLC), except for radar plots, which were produced in Microsoft® Excel® for Microsoft 365 MSO (Version 2202, Microsoft Corporation). In vitro data is reported as mean of duplicate or triplicate runs, as specified in the methods. Food-derived AA concentrations measured in the digesta were expressed per ‘mg bread dry matter’ or ‘per roll served’ to facilitate comparison to the human study data. Human study data is reported as mean with SD, unless otherwise specified. Outliers were identified and excluded from group mean serum AA data by performing ROUT (Q=1%). Postprandial responses (i.e. change from fasted values following meal consumption) were calculated by subtracting fasted values (−10 min?) from measured values at subsequent time points within each individual. ΔPeak, defined here as the maximum postprandial rise in AA concentration, were then calculated for each individual participant for each AA following after each bread type. For statistical analysis, mixed-effects ANOVA was performed on repeated measures data, with time and treatment (bread type) as fixed-effects and individual differences as random-effects. Geisser-Greenhouse correction was applied for violation of sphericity. Post-hoc tests were performed when significant main effects were detected, and Tukey's correction for multiple-comparisons applied (multiplicity-adjusted P-values are reported). Pearson's two-tailed correlation test was performed to compare in vitro and in vivo EAA profiles. For graphical representation, the group means were plotted with error bars as SEM. The number of participants (n) who's data were included in each analysis is reported in the text or figure legends.
Al-Mana, N. M., & Robertson, M. D. (2018). Acute Effect of Resistant Starch on Food Intake, Appetite and Satiety in Overweight/Obese Males. Nutrients, 10(12), 1993. https://doi.org/https://doi.org/10.3390/nu10121993
Bajka, B. H., Pinto, A. M., Ahn-Jarvis, J., Ryden, P., Perez-Moral, N., van der Schoot, A., Stocchi, C., Bland, C., Berry, S. E., Ellis, P. R., & Edwards, C. H. (2021). The impact of replacing wheat flour with cellular legume powder on starch bioaccessibility, glycaemic response and bread roll quality: A double-blind randomised controlled trial in healthy participants. Food Hydrocoll, 114, 106565. https://doi.org/https://doi.org/10.1016/j.foodhyd.2020.106565
Beumer, J., Puschhof, J., Bauzá-Martinez, J., Martinez-Silgado, A., Elmentaite, R., James, K. R., Ross, A., Hendriks, D., Artegiani, B., Busslinger, G. A., Ponsioen, B., Andersson-Rolf, A., Saftien, A., Boot, C., Kretzschmar, K., Geurts, M. H., Bar-Ephraim, Y. E., Pleguezuelos-Manzano, C., Post, Y., . . . . Clevers, H. (2020). High-Resolution mRNA and Secretome Atlas of Human Enteroendocrine Cells. Cell, 181(6), 1291-1306.e1219. https://doi.org/https://doi.org/10.1016/j.cell.2020.04.036
Bhattarai, R. R., Dhital, S., Wu, P., Chen, X. D., & Gidley, M. J. (2017). Digestion of isolated legume cells in a stomach-duodenum model: three mechanisms limit starch and protein hydrolysis [https://doi.org/10.1039/C7FO00086C]. Food & Function, 8(7), 2573-2582. https://doi.org/https://doi.org/10.1039/C7FO00086C
Brodkorb, A., Egger, L., Alminger, M., Alvito, P., Assunção, R., Ballance, S., Bohn, T., Bourlieu-Lacanal, C., Boutrou, R., & Carrière, F. (2019). INFOGEST static in vitro simulation of gastrointestinal food digestion. Nature protocols, 14(4), 991-1014.
Brodkorb, A., Egger, L., Alminger, M., Alvito, P., Assunção, R., Ballance, S., Bohn, T., Bourlieu-Lacanal, C., Boutrou, R., Carrière, F., Clemente, A., Corredig, M., Dupont, D., Dufour, C., Edwards, C., Golding, M., Karakaya, S., Kirkhus, B., Le Feunteun, S., . . . . Recio, I. (2019). INFOGEST static in vitro simulation of gastrointestinal food digestion. Nature Protocols, 14(4), 991-1014. https://doi.org/https://doi.org/10.1038/s41596-018-0119-1
Butterworth, P. J., Edwards, C. H., Ellis, P. R., Sandra, H., Marson, A., & Obuchowicz, J. (2021). Medium/low glycaemic index products and methods. In: Google Patents.
Cai, M., Dou, B., Pugh, J. E., Lett, A. M., & Frost, G. S. (2021). The impact of starchy food structure on postprandial glycemic response and appetite: a systematic review with meta-analysis of randomized crossover trials. Am J Clin Nutr, 114(2), 472-487. https://doi.org/https://doi.org/10.1093/ajcn/ngab098
Canfora, E. E., van der Beek, C. M., Jocken, J. W. E., Goossens, G. H., Holst, J. J., Olde Damink, S. W. M., Lenaerts, K., Dejong, C. H. C., & Blaak, E. E. (2017). Colonic infusions of short-chain fatty acid mixtures promote energy metabolism in overweight/obese men: a randomized crossover trial. Scientific Reports, 7(1), 2360-2360. https://doi or/https://doi.org/10.1038/s41598-017-02546-x
Capuano, E., & Pellegrini, N. (2019). An integrated look at the effect of structure on nutrient bioavailability in plant foods. Journal of the Science of Food and Agriculture, 99(2), 493-498. https://doi.org/https://doi.org/10.1002/jsfa.9298
Chambers, E. S., Morrison, D. J., & Frost, G. (2015). Control of appetite and energy intake by SCFA: what are the potential underlying mechanisms? Proc Nutr Soc. 74(3), 328-336. https://doi.org/https://doi.org/10.1017/s0029665114001657
Christiansen, C. B., Gabe, M. B. N., Svendsen, B., Dragsted, L. O., Rosenkilde, M. M., & Holst, J. J. (2018). The impact of short-chain fatty acids on GLP-1 and PYY secretion from the isolated perfused rat colon. American Journal of Physiology-Gastrointestinal and Liver Physiology, 315(1), G53-G65. https://doi.org/https://doi.org/10.1152/ajpgi.00346.2017
Christiansen, C. B., Veedfald, S., Hartmann, B., Gauguin, A. M., Møller, S., Moritz, T., Madsbad, S., & Holst, J. J. (2021). Colonic Lactulose Fermentation Has No Impact on Glucagon-like Peptide-1 and Peptide-YY Secretion in Healthy Young Men. The Journal of Clinical Endocrinology & Metabolism, 107(1), 77-87. https://doi.org/https://doi.org/10.1210/clinem/dgab666
Dagbasi, A., Byrne, C., Contreras, I., Murphy, K., & Frost, G. (2020). Understanding the Interplay Between Food Structure, Bacterial Fermentation and Appetite Sensing: A Randomized Crossover Human Trial. Current Developments in Nutrition, 4(Supplement_2), 619-619. https://doi.org/https://doi.org/10.1093/cdn/nzaa049_012
Dagbasi, A., Lett, A. M., Murphy, K., & Frost, G. (2020). Understanding the interplay between food structure, intestinal bacterial fermentation and appetite control. Proceedings of the Nutrition Society, 1-17. https://doi.org/https://doi.org/10.1017/S0029665120006941
Delamare, G. Y. F., Butterworth, P. J., Ellis, P. R., Hill, S., Warren, F. J., & Edwards, C. H. (2020). Incorporation of a novel leguminous ingredient into savoury biscuits reduces their starch digestibility: Implications for lowering the Glycaemic Index of cereal products. Food Chemistry: X, 5, 100078. https://doi.org/https://doi.org/10.1016/j.fochx2020.100078
Dhital, S., Bhattarai, R. R., Gorham, J., & Gidley, M. J. (2016). Intactness of cell wall structure controls the in vitro digestion of starch in legumes [10.1039/C5FO01104C]. Food & Function, 7(3), 1367-1379. https://doi.org/https://doi.org/10.1039/CSFO01104C
Duijsens, D., Pälchen, K., De Coster, A., Verkempinck, S. H. E., Hendrickx, M. E., & Grauwet, T. (2022). Effect of manufacturing conditions on in vitro starch and protein digestibility of (cellular) lentil-based ingredients. Food Research International, 158, 111546. https://doi.org/https://doi.org/10.1016/j.foodres.2022.111546
Edwards, C. H. (2014). The role of plant cell walls in influencing starch bioaccessibility King's College London].
Edwards, C. H., Cochetel, N., Setterfield, L., Perez-Moral, N., & Warren, F. J. (2019). A single-enzyme system for starch digestibility screening and its relevance to understanding and predicting the glycaemic index of food products. Food & Function, 10(8), 4751-4760. https://doi.org/https://doi.org/10.1039/C9FO00603F
Edwards, C. H., Maillot, M., Parker, R., & Warren, F. J. (2018). A comparison of the kinetics of in vitro starch digestion in smooth and wrinkled peas by porcine pancreatic alpha-amylase. Food Chemistry, 244, 386-393. https://doi.org/https://doi.org/10.1016/j.foodchem.2017.10.042
Edwards, C. H., Ryden, P., Mandalari, G., Butterworth, P. J., & Ellis, P. R. (2021). Structure-function studies of chickpea and durum wheat uncover mechanisms by which cell wall properties influence starch bioaccessibility. Nature Food, 2(2), 118-126. https://doi.org/https://doi.org/10.1038/s43016-021-00230-v
Edwards, C. H., Ryden, P., Pinto, A. M., van der Schoot, A., Stocchi, C., Perez-Moral, N., Butterworth, P. J., Bajka, B., Berry, S. E., & Hill, S. E. (2020). Chemical, physical and glycaemic characterisation of PulseON®: A novel legume cell-powder ingredient for use in the design of functional foods. Journal of Functional Foods, 68, 103918.
Edwards, C. H., Ryden, P., Pinto, A. M., van der Schoot, A., Stocchi, C., Perez-Moral, N., Butterworth, P. J., Bajka, B., Berry, S. E., Hill, S. E., & Ellis, P. R. (2020). Chemical, physical and glycaemic characterisation of PulseON®: A novel legume cell-powder ingredient for use in the design of functional foods. Journal of Functional Foods, 68, 103918. https://doi.org/https://doi.org/10.1016/j.jff.2020.103918
Ellis, P. R., Kendall, C. W., Ren, Y., Parker, C., Pacy, J. F., Waldron, K. W., & Jenkins, D. J. (2004). Role of cell walls in the bioaccessibility of lipids in almond seeds. Am J Clin Nutr, 80(3), 604-613. https://doi.org/https://doi.org/10.1093/aicn/80.3.604
Ellis, P. R., Roberts, F. G., Low, A. G., & Morgan, L. M. (1995). The effect of high-molecular-weight guar gum on net apparent glucose absorption and net apparent insulin and gastric inhibitory polypeptide production in the growing pig: relationship to rheological changes in jejunal digesta. Br J Nutr, 74(4), 539-556. https://doi.org/https://doi.org/10.1079/bin19950157
Fardet, A. (2016). Minimally processed foods are more satiating and less hyperglycemic than ultra-processed foods: a preliminary study with 98 ready-to-eat foods [10.1039/C6FO00107F]. Food & Function, 7(5), 2338-2346. https://doi.org/https://doi.org/10.1039/C6FO00107F
Flint, A., Raben, A., Astrup, A., & Holst, J. J. (1998). Glucagon-like peptide 1 promotes satiety and suppresses energy intake in humans. Journal of Clinical Investigation, 101(3), 515-520. https://doi.org/https://doi.org/10.1172/jci990
Gibbons, C., Hopkins, M., Beaulieu, K., Oustric, P., & Blundell, J. E. (2019). Issues in Measuring and Interpreting Human Appetite (Satiety/Satiation) and Its Contribution to Obesity. Current Obesity Reports, 8(2), 77-87. https://doi.org/https://doi.org/10.1007/s13679-019-00340-6
Golay, A., Coulston, A. M., Hollenbeck, C. B., Kaiser, L. L., Wursch, P., & Reaven, G. M. (1986). Comparison of metabolic effects of white beans processed into 2 different physical forms. Diabetes Care, 9(3), 260-266.
Grundy, M. M.-L., Edwards, C. H., Mackie, A. R., Gidley, M. J., Butterworth, P. J., & Ellis, P. R. (2016). Re-evaluation of the mechanisms of dietary fibre and implications for macronutrient bioaccessibility, digestion and postprandial metabolism. British Journal of Nutrition, 116(5), 816-833. https://doi.org/https://doi.org/10.1017/S0007114516002610
Grundy, M. M. L., Edwards, C. H., Mackie, A. R., Gidley, M. J., Butterworth, P. J., & Ellis, P. R. (2016). Re-evaluation of the mechanisms of dietary fibre and implications for macronutrient bioaccessibility, digestion and postprandial metabolism. British Journal of Nutrition, 116(5), 816-833. https://doi.org/10.1017/S0007114516002610
Holland, C., Ryden, P., Edwards, C. H., & Grundy, M. M.-L. (2020). Plant cell walls: impact on nutrient bioaccessibility and digestibility. Foods, 9(2), 201. https://doi.org/https://doi.org/10.3390/foods9020201
Jarvis, M. C., Briggs, S. P. H., & Knox, J. P. (2003). Intercellular adhesion and cell separation in plants. Plant, Cell & Environment, 26(7), 977-989. https://doi.org/https://doi.org/10.1046/j. 1365-3040.2003.01034.x
Kim, S. J., de Souza, R. J., Choo, V. L., Ha, V., Cozma, A. I., Chiavaroli, L., Mirrahimi, A., Blanco Mejia, S., Di Buono, M., Bernstein, A. M., Leiter, L. A., Kris-Etherton, P. M., Vuksan, V., Beyene, J., Kendall, C. W., Jenkins, D. J., & Sievenpiper, J. L. (2016). Effects of dietary pulse consumption on body weight: a systematic review and meta-analysis of randomized controlled trials. Am J Clin Nutr, 103(5), 1213-1223. https://doi.org/https://doi.org/10.3945/aicn.115.124677
Knudsen, L. B., & Lau, J. (2019). The Discovery and Development of Liraglutide and Semaglutide [Review]. Frontiers in Endocrinology, 10(155). https://doi.org/https://doi.org/10.3389/fendo.2019.00155
Kok, M. G. M., Nix, C., Nys, G., & Fillet, M. (2019). Targeted metabolomics of whole blood using volumetric absorptive microsampling. Talanta, 197, 49-58. https://doi.org/https://doi org/10.1016/j.talanta.2019.01.014
Kong, F., & Singh, R. P. (2009). Digestion of raw and roasted almonds in simulated gastric environment. Food Biophys, 4(4), 365-377. https://doi.org/DOI 10.1007/s11483-009-9135-6
Lever, M. (1972). A new reaction for colorimetric determination of carbohydrates. Analytical Biochemistry, 47(1), 273-279. https://doi.org/http://dx.doi.org/10.1016/0003-2697(72)90301-6
Lockyer, S., & Spiro, A. (2020). The role of bread in the UK diet: An update. Nutrition Bulletin, 45(2), 133-164. https://doi.org/https://doi.org/10.1111/nbu.12435
Maljaars, P. W. J., Peters, H. P. F., Mela, D. J., & Masclee, A. A. M. (2008). Ileal brake: a sensible food target for appetite control. A review. Physiol Behav, 95(3), 271-281. https://doi.org/https://doi.org/10.1016/j.physbeh.2008.07.018
Melito, C., & Tovar, J. (1995). Cell walls limit in vitro protein digestibility in processed legume seeds. Food Chemistry, 53(3), 305-307. https://doi.org/https://doi.org/10.1016/0308-8146(95)93937-M
Mozaffarian, D., Hao, T., Rimm, E. B., Willett, W. C., & Hu, F. B. (2011). Changes in diet and lifestyle and long-term weight gain in women and men. N Engl J Med, 364(25), 2392-2404. https://doi.org/https://doi.org/10.1056/NEJMoa1014296
Noah, L., Guillon, F., Bouchet, B., Buleon, A., Molis, C., Gratas, M., & Champ, M. (1998). Digestion of carbohydrate from white beans (Phaseolus vulgaris L.) in healthy humans. J Nutr, 128(6) 977-985. http://www.ncbi.nlm.nih.gov/pubmed/9614157
Pais, R., Gribble, F. M., & Reimann, F. (2016). Stimulation of incretin secreting cells. Therapeutic Advances in Endocrinology and Metabolism, 7(1), 24-42. https://doi.org/https://doi.org/10.1177/2042018815618177
Pälchen, K., Bredie, W. L. P., Duijsens, D., Isaac Alfie Castillo, A., Hendrickx, M., Van Loey, A., Raben, A., & Grauwet, T. (2022). Effect of processing and microstructural properties of chickpea-flours on in vitro digestion and appetite sensations. Food Research International, 157, 111245. https://doi.org/https://doi.org/10.1016/j.foodres.2022.111245
Pälchen, K., Michels, D., Duijsens, D., Gwala, S., Pallares Pallares, A., Hendrickx, M., Van Loey, A., & Grauwet, T. (2021). In vitro protein and starch digestion kinetics of individual chickpea cells: from static to more complex in vitro digestion approaches [10.1039/DIFO01123E]. Food & Function. https://doi.org/https://doi.org/10.1039/DIFO01123E
Pallares Pallares, A., Alvarez Miranda, B., Truong, N. Q. A., Kyomugasho, C., Chigwedere, C. M., Hendrickx, M., & Grauwet, T. (2018). Process-induced cell wall permeability modulates the in vitro starch digestion kinetics of common bean cotyledon cells [10.1039/C8FO01619D]. Food & Function, 9(12), 6544-6554. https://doi.org/https://doi.org/10.1039/C8FO01619D
Pallares Pallares, A., Gwala, S., Pälchen, K., Duijsens, D., Hendrickx, M., & Grauwet, T. (2021). Pulse seeds as promising and sustainable source of ingredients with naturally bioencapsulated nutrients: Literature review and outlook. Comprehensive Reviews in Food Science and Food Safety, 20(2), 1524-1553. https://doi.org/https://doi.org/10.1111/1541-4337.12692
Papanikolaou, Y., & Fulgoni, V. L., 3rd. (2008). Bean consumption is associated with greater nutrient intake, reduced systolic blood pressure, lower body weight, and a smaller waist circumference in adults: results from the National Health and Nutrition Examination Survey 1999-2002. J Am Coll Nutr, 27(5), 569-576. https://doi.org/https://doi.org/10.1080/07315724.2008.10719740
Parada, J., & Aguilera, J. M. (2011). Review: Starch matrices and the glycemic response. Food Science and Technology International, 17(3), 187-204. https://doi.org/https://doi.org/10.1177/1082013210387712
Petropoulou, K., Salt, L. J., Edwards, C. H., Warren, F. J., Garcia-Perez, I., Chambers, E. S., Alshaalan, R., Khatib, M., Perez-Moral, N., Cross, K. L., Kellingray, L., Stanley, R., Koev, T., Khimyak, Y. Z., Narbad, A., Penney, N., Serrano-Contreras, J. I., Charalambides, M. N., Miguens Blanco, J., . . . . Frost, G. S. (2020). A natural mutation in Pisum sativum L. (pea) alters starch assembly and improves glucose homeostasis in humans. Nature Food. https://doi.org/https://doi.org/10.1038/s43016-020-00159-8
Ramdath, D., Renwick, S., & Duncan, A. M. (2016). The Role of Pulses in the Dietary Management of Diabetes. Can J Diabetes, 40(4), 355-363. https://doi.org/10.1016/.icid.2016.05.015
Reimann, F., & Gribble, F. M. (2016). Mechanisms underlying glucose-dependent insulinotropic polypeptide and glucagon-like peptide-1 secretion. Journal of Diabetes Investigation, 7 Suppl 1(Suppl 1), 13-19. https://doi.org/https://doi.org/10.1111/jdi.12478
Reynolds, A., Mann, J., Cummings, J., Winter, N., Mete, E., & Te Morenga, L. (2019). Carbohydrate quality and human health: a series of systematic reviews and meta-analyses. The Lancet, 393(10170), 434-445. https://doi.org/https://doi.org/10.1016/80140-6736(18)31809-9
Roux, L. L., Chacon, R., Dupont, D., Jeantet, R., Deglaire, A., & Nau, F. (2020). In vitro static digestion reveals how plant proteins modulate model infant formula digestibility. Food Res Int, 130, 108917. https://doi.org/10.1016/j.foodres.2019.108917
Rovalino-Córdova, A. M., Fogliano, V., & Capuano, E. (2018). A closer look to cell structural barriers affecting starch digestibility in beans. Carbohydrate Polymers, 181, 994-1002. https://doi.org/https://doi.org/10.1016/j.carbpol.2017.11.050
Rovalino-Córdova, A. M., Fogliano, V., & Capuano, E. (2019). The effect of cell wall encapsulation on macronutrients digestion: A case study in kidney beans. Food Chemistry, 286, 557-566. https://doi.org/https://doi.org/10.1016/j.foodchem.2019.02.057
Santos-Hernández, M., Miralles, B., Amigo, L., & Recio, I. (2018). Intestinal Signaling of Proteins and Digestion-Derived Products Relevant to Satiety. J Agric Food Chem, 66(39), 10123-10131. https://doi.org/10.1021/acs.jafc.8b02355
Sievenpiper, J. L., Kendall, C. W. C., Esfahani, A., Wong, J. M. W., Carleton, A. J., Jiang, H. Y., Bazinet, R. P., Vidgen, E., & Jenkins, D. J. A. (2009). Effect of non-oil-seed pulses on glycaemic control: a systematic review and meta-analysis of randomised controlled experimental trials in people with and without diabetes [journal article]. Diabetologia, 52(8), 1479. https://doi.org/https://doi org/10.1007/s00125-009-1395-7
Steinert, R. E., Feinle-Bisset, C., Asarian, L., Horowitz, M., Beglinger, C., & Geary, N. (2017). Ghrelin, CCK, GLP-1, and PYY (3-36): Secretory Controls and Physiological Roles in Eating and Glycemia in Health, Obesity, and After RYGB. Physiological reviews, 97(1), 411-463. https://doi.org/https://doi.org/10.1152/physrey.00031.2014
Swinburn, B. A., Sacks, G., Hall, K. D., McPherson, K., Finegood, D. T., Moodie, M. L., & Gortmaker, S. L. (2011). The global obesity pandemic: shaped by global drivers and local environments. The Lancet, 378(9793), 804-814. https://doi.org/https://doi.org/10.1016/80140-6736(11)60813-1
Tovar, J., Granfeldt, Y., & Björck, I. M. (1992). Effect of processing on blood glucose and insulin responses to starch in legumes. J Agric Food Chem, 40(10), 1846-1851. https://doi.org/https://doi.org/10.1021/100022a024
Verkempinck, S., Pallares, A. P., Hendrickx, M., & Grauwet, T. (2020). Processing as a tool to manage digestive barriers in plant-based foods: recent advances. Current Opinion in Food Science, 35, 1-9. https://doi.org/https://doi.org/10.1016/j.cofs.2019.11.007
Viguiliouk, E., Glenn, A. J., Nishi, S. K., Chiavaroli, L., Seider, M., Khan, T., Bonaccio, M., Iacoviello, L., Mejia, S. B., Jenkins, D. J. A., Kendall, C. W. C., Kahleová, H., Rahelić, D., Salas-Salvadó, J., & Sievenpiper, J. L. (2019). Associations between Dietary Pulses Alone or with Other Legumes and Cardiometabolic Disease Outcomes: An Umbrella Review and Updated Systematic Review and Meta-analysis of Prospective Cohort Studies. Advances in Nutrition, 10(Supplement_4), S308-S319. https://doi.org/https://doi.org/10.1093/advances/nmz113
Wang, X. J., Burton, D. D., Breen-Lyles, M., & Camilleri, M. (2021). Gastric accommodation influences proximal gastric and total gastric emptying in concurrent measurements conducted in healthy volunteers. American Journal of Physiology-Gastrointestinal and Liver Physiology, 320(5), G759-G767. https://doi.org/https://doi.org/10.1152/ajpgi.00008.2021
Würsch, P., Del Vedovo, S., & Koellreutter, B. (1986). Cell structure and starch nature as key determinants of the digestion rate of starch in legume. Am J Clin Nutr, 43, 25-29.
Wyatt, P., Berry, S. E., Finlayson, G., O'Driscoll, R., Hadjigeorgiou, G., Drew, D. A., Khatib, H. A., Nguyen, L. H., Linenberg, I., Chan, A. T., Spector, T. D., Franks, P. W., Wolf, J., Blundell, J., & Valdes, A. M. (2021). Postprandial glycaemic dips predict appetite and energy intake in healthy individuals. Nature Metabolism, 3(4), 523-529. https://doi.org/https://doi.org/10.1038/s42255-021-00383-x
Xiong, W., Devkota, L., Zhang, B., Muir, J., & Dhital, S. (2022). Intact cells: “Nutritional capsules” in plant foods. Comprehensive Reviews in Food Science and Food Safety. https://doi.org/https://doi.org/10.1111/1541-4337.12904
Zou, W., Sissons, M., Warren, F. J., Gidley, M. J., & Gilbert, R. G. (2016). Compact structure and proteins of pasta retard in vitro digestive evolution of branched starch molecular structure. Carbohydrate Polymers, 152, 441-449. https://doi.org/https://doi.org/10.1016/j.carbpol. 2016.06.016

1. A dietary composition wherein the fibre structure of said composition influences enteroendocrine-mediated appetite regulation, wherein said composition includes cellular legume powder, wherein the cellular legume powder comprises intact cells from at least one legume.

2-3. (canceled)

4. The dietary composition according to claim 1 wherein the composition includes at least 10% by weight cellular legume powder.

5. (canceled)

6. The dietary composition according to claim 1 wherein the legume is from a Fabaceae family.

7. The dietary composition according to claim 1 wherein the cellular powder is cellular chickpea powder.

8. The dietary composition according to claim 1 wherein the cellular powder is included as an ingredient in a foodstuff and/or foodstuff formulation or precursor replacing refined flours in said foodstuff.

9-12. (canceled)

13. The dietary composition according to claim 8 wherein use of cellular flour or the cellular powder results in significantly elevated and/or sustained release of gut hormones.

14. The dietary composition according to claim 8 wherein use of cellular flour and/or the cellular powder results in increased satiety and/or attenuated postprandial glycaemia.

15. The dietary composition according to claim 14 wherein the composition includes up to substantially 60% wt cellular powder.

16. The dietary composition according to claim 15 wherein the composition includes substantially 30-60% wt cellular powder.

17. A method of influencing enteroendocrine-mediated appetite regulation by inclusion of cellular legume powder in a foodstuff or foodstuff precursor, wherein the cellular legume powder comprises intact legume cells.

18. The method according to claim 17 wherein the intact cells influence any one or any combination of gastric inhibitory polypeptide (GIP), glucagon-like peptide 1 (GLP-1) and peptide-YY (PYY).

19. A flour composition that influences enteroendocrine-mediated appetite regulation by inclusion of cellular legume powder in the flour composition, wherein the cellular legume powder comprises intact legume cells.

20-21. (canceled)

22. The flour composition according to claim 19 wherein the legumes are peas or chickpeas provided in powder or flour.

23. A method of modifying foodstuffs to provide controlled release of free amino acids, by including substantially intact cells from at least one legume.

24-29. (canceled)

30. The method of influencing enteroendocrine-mediated appetite regulation by inclusion of intact legume cells in foodstuffs and/or foodstuff precursors to provide a higher amount of bioavailable total free amino acids, by including substantially intact cells from at least one legume.
